(19) United States
(12) Patent Application Publication
(10) Pub. No.: US 2025/0039799 A1
(43) Pub. Date: Jan. 30, 2025

(54) TECHNIQUES FOR MULTIPLE PRACH TRANSMISSIONS

(71) Applicant: QUALCOMM Incorporated, San Diego, CA (US)

(72) Inventors: Kexin XIAO, Shanghai (CN); Hung Dinh LY, San Diego, CA (US); Hwan Joon KWON, San Diego, CA (US)

(21) Appl. No.: 18/718,593

(22) PCT Filed: Mar. 2, 2022
(86) PCT No.: PCT/CN2022/078748

§ 371 Date: Jun. 11, 2024

(51) Int. Cl. H04W 52/14; H04W 52/50; H04W 74/0833

(52) U.S. Cl. CPC H04W 52/146; H04W 52/50; H04W 74/0833

(57) ABSTRACT

Methods, systems, and devices for wireless communications are described. A user equipment (UE) may be configured to transmit multiple repetitions of a random access message using multiple spatial filters. In some cases, the UE may transmit each repetition of the random access message using a same transmission power determined based on one of the spatial filters. In other cases, the UE may transmit each repetition of the random access message using a different transmission power determined in accordance with power control parameters corresponding to the respective spatial filters. The UE may utilize a spatial filter of a first-received responsive random access message to perform subsequent transmissions of a random access procedure. In the case of a failure of the random access procedure, the UE may increment (or refrain from incrementing) a power ramping counter based on spatial filters used to re-initiate the random access procedure.

### CROSS REFERENCE

The present Application is a 371 national phase filing of International PCT Application No. PCT/CN2022/078748 by XIAO et al., entitled “TECHNIQUES FOR MULTIPLE PRACH TRANSMISSIONS,” filed Mar. 2, 2022, which is assigned to the assignee hereof, and which is expressly incorporated by reference in its entirety herein.

### FIELD OF TECHNOLOGY

The following relates to wireless communications, including techniques for multiple physical random access channel (PRACH) transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, wireless devices (e.g., UEs) may perform random access channel (RACH) procedures with the network in order to establish wireless connections with the network. RACH procedures may include 2-step or 4-step RACH procedures, in which a UE and the network exchange messages in an alternating “handshaking” manner to establish wireless communications. However, in cases where UEs (and the network) transmit RACH messages using multiple beams or spatial filters, it may be unclear what beam/spatial filter should be used, as well as what transmission power the UE should use to perform the respective RACH messages.

### SUMMARY

The described techniques relate to improved methods, systems, devices, and apparatuses that support techniques for multiple physical random access channel (PRACH) transmissions. Generally, aspects of the present disclosure are directed to new signaling and rules for determining transmission powers used for transmitting multiple repetitions of random access channel (RACH) messages, and for determining which spatial filter will be used to perform a RACH message when a user equipment (UE) transmits multiple repetitions of a RACH message using multiple spatial filters. For example, a UE may be configured to determine a transmission power used for multiple RACH messages of a RACH procedure based on one of the spatial filters that will be used to transmit the RACH messages. In alternative implementations, the UE may determine a transmission power of each respective RACH message based on a set of power control parameters corresponding to the respective spatial filter that will be used. Rules for incrementing a power control counter may be used to determine transmission powers of RACH messages when a UE re-initiates a failed RACH procedure. Moreover, in accordance with some aspects of the present disclosure, a UE may utilize a spatial filter associated with the first RACH message received from the network in order to perform subsequent RACH messages.

A method for wireless communication at a UE is described. The method may include receiving a set of multiple reference signals associated with a set of multiple spatial filters, transmitting, using a transmission power based on a single spatial filter of the set of multiple spatial filters, a first random access message of a random access procedure with a first spatial filter of the set of multiple spatial filters, and transmitting, using the transmission power based on the single spatial filter of the set of multiple spatial filters, a second random access message of the random access procedure with a second spatial filter of the set of multiple spatial filters.

An apparatus for wireless communication at a UE is described. The apparatus may include a processor, memory coupled with the processor, and instructions stored in the memory. The instructions may be executable by the processor to cause the apparatus to receive a set of multiple reference signals associated with a set of multiple spatial filters, transmit, using a transmission power based on a single spatial filter of the set of multiple spatial filters, a first random access message of a random access procedure with a first spatial filter of the set of multiple spatial filters, and transmit, using the transmission power based on the single spatial filter of the set of multiple spatial filters, a second random access message of the random access procedure with a second spatial filter of the set of multiple spatial filters.

Another apparatus for wireless communication at a UE is described. The apparatus may include means for receiving a set of multiple reference signals associated with a set of multiple spatial filters, means for transmitting, using a transmission power based on a single spatial filter of the set of multiple spatial filters, a first random access message of a random access procedure with a first spatial filter of the set of multiple spatial filters, and means for transmitting, using the transmission power based on the single spatial filter of the set of multiple spatial filters, a second random access message of the random access procedure with a second spatial filter of the set of multiple spatial filters.

A non-transitory computer-readable medium storing code for wireless communication at a UE is described. The code may include instructions executable by a processor to receive a set of multiple reference signals associated with a set of multiple spatial filters, transmit, using a transmission power based on a single spatial filter of the set of multiple spatial filters, a first random access message of a random access procedure with a first spatial filter of the set of multiple spatial filters, and transmit, using the transmission power based on the single spatial filter of the set of multiple spatial filters, a second random access message of the random access procedure with a second spatial filter of the set of multiple spatial filters.

In some examples of the method, apparatuses, and non-transitory computer-readable medium described herein, the transmission power may be based on a pathloss metric associated with the single spatial filter.

Some examples of the method, apparatuses, and non-transitory computer-readable medium described herein may further include operations, features, means, or instructions for performing measurements on the set of multiple reference signals, determining a set of multiple sets of characteristics associated with the set of multiple spatial filters based on the measurements, the set of multiple sets of characteristics including a first set of characteristics associated with the first spatial filter and a second set of characteristics associated with the second spatial filter, the set of multiple sets of characteristics including a reference signal received power (RSRP) measurement, a pathloss metric, or both, and selecting the single spatial filter associated with the transmission power based on a comparison of the first set of characteristics, the second set of characteristics, or both, with the set of multiple sets of characteristics.

Some examples of the method, apparatuses, and non-transitory computer-readable medium described herein may further include operations, features, means, or instructions for receiving control signaling indicating one or more parameters associated with selection of spatial filters at the UE, where the single spatial filter may be selected in accordance with the one or more parameters.

In some examples of the method, apparatuses, and non-transitory computer-readable medium described herein, the set of multiple reference signals include a synchronization signal block (SSB) message, a channel state information reference signal (CSI-RS), or both.

In some examples of the method, apparatuses, and non-transitory computer-readable medium described herein, the random access procedure includes a four-step random access procedure or a two-step random access procedure.

In some examples of the method, apparatuses, and non-transitory computer-readable medium described herein, the random access procedure includes a four-step random access procedure and the first random access message, the second random access message, or both, include repetitions of a first message of the four-step random access procedure.

A method for wireless communication at a UE is described. The method may include receiving control signaling indicating a set of multiple sets of power control parameters associated with a set of multiple spatial filters, transmitting, using a first transmission power and in accordance with a first spatial filter of the set of multiple spatial filters, a first random access message of a random access procedure, where the first transmission power is based on a first set of power control parameters associated with the first spatial filter indicated via the control signaling, the first set of power control parameters included within the set of multiple sets of power control parameters, and transmitting, using a second transmission power and in accordance with a second spatial filter of the set of multiple spatial filters, a second random access message of the random access procedure, where the second transmission power is based on a second set of power control parameters associated with the second spatial filter indicated via the control signaling, the second set of power control parameters included within the set of multiple sets of power control parameters.

An apparatus for wireless communication at a UE is described. The apparatus may include a processor, memory coupled with the processor, and instructions stored in the memory. The instructions may be executable by the processor to cause the apparatus to receive control signaling indicating a set of multiple sets of power control parameters associated with a set of multiple spatial filters, transmit, using a first transmission power and in accordance with a first spatial filter of the set of multiple spatial filters, a first random access message of a random access procedure, where the first transmission power is based on a first set of power control parameters associated with the first spatial filter indicated via the control signaling, the first set of power control parameters included within the set of multiple sets of power control parameters, and transmit, using a second transmission power and in accordance with a second spatial filter of the set of multiple spatial filters, a second random access message of the random access procedure, where the second transmission power is based on a second set of power control parameters associated with the second spatial filter indicated via the control signaling, the second set of power control parameters included within the set of multiple sets of power control parameters.

Another apparatus for wireless communication at a UE is described. The apparatus may include means for receiving control signaling indicating a set of multiple sets of power control parameters associated with a set of multiple spatial filters, means for transmitting, using a first transmission power and in accordance with a first spatial filter of the set of multiple spatial filters, a first random access message of a random access procedure, where the first transmission power is based on a first set of power control parameters associated with the first spatial filter indicated via the control signaling, the first set of power control parameters included within the set of multiple sets of power control parameters, and means for transmitting, using a second transmission power and in accordance with a second spatial filter of the set of multiple spatial filters, a second random access message of the random access procedure, where the second transmission power is based on a second set of power control parameters associated with the second spatial filter indicated via the control signaling, the second set of power control parameters included within the set of multiple sets of power control parameters.

A non-transitory computer-readable medium storing code for wireless communication at a UE is described. The code may include instructions executable by a processor to receive control signaling indicating a set of multiple sets of power control parameters associated with a set of multiple spatial filters, transmit, using a first transmission power and in accordance with a first spatial filter of the set of multiple spatial filters, a first random access message of a random access procedure, where the first transmission power is based on a first set of power control parameters associated with the first spatial filter indicated via the control signaling, the first set of power control parameters included within the set of multiple sets of power control parameters, and transmit, using a second transmission power and in accordance with a second spatial filter of the set of multiple spatial filters, a second random access message of the random access procedure, where the second transmission power is based on a second set of power control parameters associated with the second spatial filter indicated via the control signaling, the second set of power control parameters included within the set of multiple sets of power control parameters.

In some examples of the method, apparatuses, and non-transitory computer-readable medium described herein, the first transmission power may be based on a first pathloss metric and the first set of power control parameters and the second transmission power may be based on a second pathloss metric and the second set of power control parameters.

Some examples of the method, apparatuses, and non-transitory computer-readable medium described herein may further include operations, features, means, or instructions for selecting the first spatial filter and the second spatial filter based on a comparison of a first set of characteristics associated with the first spatial filter, a second set of characteristics associated with the second spatial filter, or both, with a set of multiple sets of characteristics associated with the set of multiple spatial filters, where the first set of characteristics, the second set of characteristics, or both, include an RSRP measurement, a pathloss metric, or both, where transmitting the first and second random access messages may be based on selecting the first and second spatial filters.

Some examples of the method, apparatuses, and non-transitory computer-readable medium described herein may further include operations, features, means, or instructions for receiving a set of multiple reference signals including an SSB message, a CSI-RS, or both, where the set of multiple sets of characteristics may be based on the set of multiple reference signals.

In some examples of the method, apparatuses, and non-transitory computer-readable medium described herein, the set of multiple sets of power control parameters include a preamble received target power parameter, a maximum transmission parameter, a power ramping step parameter, or any combination thereof.

In some examples of the method, apparatuses, and non-transitory computer-readable medium described herein, the random access procedure includes a four-step random access procedure or a two-step random access procedure.

In some examples of the method, apparatuses, and non-transitory computer-readable medium described herein, the random access procedure includes a four-step random access procedure and the first random access message, the second random access message, or both, include a first message of the four-step random access procedure.

A method for wireless communication at a UE is described. The method may include receiving a set of multiple reference signals associated with a set of multiple spatial filters, transmitting, based on receiving the set of multiple reference signals, a first random access message and a second random access message of a random access procedure, the first and second random access messages transmitted in accordance with a first spatial filter and a second spatial filter from the set of multiple spatial filters, respectively, receiving, based on the first random access message, the second random access message, or both, a third random access message of the random access procedure, where the third random access message is associated with one of the first spatial filter or the second spatial filter, and transmitting, based on the third random access message, a fourth random access message of the random access procedure, where the fourth random access message is transmitted in accordance with the first spatial filter or the second spatial filter that is associated with the third random access message.

An apparatus for wireless communication at a UE is described. The apparatus may include a processor, memory coupled with the processor, and instructions stored in the memory. The instructions may be executable by the processor to cause the apparatus to receive a set of multiple reference signals associated with a set of multiple spatial filters, transmit, based on receiving the set of multiple reference signals, a first random access message and a second random access message of a random access procedure, the first and second random access messages transmitted in accordance with a first spatial filter and a second spatial filter from the set of multiple spatial filters, respectively, receive, based on the first random access message, the second random access message, or both, a third random access message of the random access procedure, where the third random access message is associated with one of the first spatial filter or the second spatial filter, and transmit, based on the third random access message, a fourth random access message of the random access procedure, where the fourth random access message is transmitted in accordance with the first spatial filter or the second spatial filter that is associated with the third random access message.

Another apparatus for wireless communication at a UE is described. The apparatus may include means for receiving a set of multiple reference signals associated with a set of multiple spatial filters, means for transmitting, based on receiving the set of multiple reference signals, a first random access message and a second random access message of a random access procedure, the first and second random access messages transmitted in accordance with a first spatial filter and a second spatial filter from the set of multiple spatial filters, respectively, means for receiving, based on the first random access message, the second random access message, or both, a third random access message of the random access procedure, where the third random access message is associated with one of the first spatial filter or the second spatial filter, and means for transmitting, based on the third random access message, a fourth random access message of the random access procedure, where the fourth random access message is transmitted in accordance with the first spatial filter or the second spatial filter that is associated with the third random access message.

A non-transitory computer-readable medium storing code for wireless communication at a UE is described. The code may include instructions executable by a processor to receive a set of multiple reference signals associated with a set of multiple spatial filters, transmit, based on receiving the set of multiple reference signals, a first random access message and a second random access message of a random access procedure, the first and second random access messages transmitted in accordance with a first spatial filter and a second spatial filter from the set of multiple spatial filters, respectively, receive, based on the first random access message, the second random access message, or both, a third random access message of the random access procedure, where the third random access message is associated with one of the first spatial filter or the second spatial filter, and transmit, based on the third random access message, a fourth random access message of the random access procedure, where the fourth random access message is transmitted in accordance with the first spatial filter or the second spatial filter that is associated with the third random access message.

Some examples of the method, apparatuses, and non-transitory computer-readable medium described herein may further include operations, features, means, or instructions for receiving, in response to the fourth random access message, a fifth random access message of the random access procedure, where the fifth random access message may be associated with the first spatial filter or the second spatial filter that may be associated with the fourth random access message.

Some examples of the method, apparatuses, and non-transitory computer-readable medium described herein may further include operations, features, means, or instructions for transmitting an acknowledgement message in response to the fifth random access message, where the acknowledgement message may be associated with a completion of the random access procedure and communicating with a network node based on the completion of the random access procedure.

In some examples of the method, apparatuses, and non-transitory computer-readable medium described herein, receiving the third random access message may include operations, features, means, or instructions for receiving a first repetition of the third random access message associated with the first spatial filter and refraining from monitoring for additional repetitions of the third random access message associated with additional spatial filters based on receiving the first repetition of the third random access message, where the fourth random access message may be transmitted in accordance with the first spatial filter based on receiving the first repetition of the third random access message associated with the first spatial filter.

In some examples of the method, apparatuses, and non-transitory computer-readable medium described herein, receiving the third random access message may include operations, features, means, or instructions for receiving a first repetition of the third random access message associated with the second spatial filter, where the fourth random access message may be transmitted in accordance with the second spatial filter based on receiving the first repetition of the third random access message associated with the second spatial filter.

Some examples of the method, apparatuses, and non-transitory computer-readable medium described herein may further include operations, features, means, or instructions for selecting the first spatial filter and the second spatial filter based on a comparison of a first pathloss metric associated with the first spatial filter, a second pathloss metric associated with the second spatial filter, or both, with a set of multiple pathloss metrics associated with the set of multiple spatial filters, where transmitting the first and second random access messages may be based on selecting the first and second spatial filters.

In some examples of the method, apparatuses, and non-transitory computer-readable medium described herein, the set of multiple reference signals include an SSB message, a CSI-RS, or both.

In some examples of the method, apparatuses, and non-transitory computer-readable medium described herein, the random access procedure includes a four-step random access procedure or a two-step random access procedure.

In some examples of the method, apparatuses, and non-transitory computer-readable medium described herein, the random access procedure includes a four-step random access procedure, the first random access message, the second random access message, or both, include repetitions of a first message of the four-step random access procedure, the third random access message includes a second message of the four-step random access procedure, and the fourth random access message includes a third message of the four-step random access procedure.

A method for wireless communication at a UE is described. The method may include transmitting a first set of random access messages of a random access procedure in accordance with a first set of one or more spatial filters, where the first set of random access messages are associated with a first value of a power ramping counter, selecting a second set of one or more spatial filters based on identifying a failure of the random access procedure, setting the power ramping counter to a value based on a comparison of the first set of one or more spatial filters and the second set of one or more spatial filters, and transmitting a second set of random access messages associated with a second random access procedure in accordance with the second set of one or more spatial filters and using a transmission power that is based on the value of the power ramping counter.

An apparatus for wireless communication at a UE is described. The apparatus may include a processor, memory coupled with the processor, and instructions stored in the memory. The instructions may be executable by the processor to cause the apparatus to transmit a first set of random access messages of a random access procedure in accordance with a first set of one or more spatial filters, where the first set of random access messages are associated with a first value of a power ramping counter, select a second set of one or more spatial filters based on identifying a failure of the random access procedure, set the power ramping counter to a value based on a comparison of the first set of one or more spatial filters and the second set of one or more spatial filters, and transmit a second set of random access messages associated with a second random access procedure in accordance with the second set of one or more spatial filters and using a transmission power that is based on the value of the power ramping counter.

Another apparatus for wireless communication at a UE is described. The apparatus may include means for transmitting a first set of random access messages of a random access procedure in accordance with a first set of one or more spatial filters, where the first set of random access messages are associated with a first value of a power ramping counter, means for selecting a second set of one or more spatial filters based on identifying a failure of the random access procedure, means for setting the power ramping counter to a value based on a comparison of the first set of one or more spatial filters and the second set of one or more spatial filters, and means for transmitting a second set of random access messages associated with a second random access procedure in accordance with the second set of one or more spatial filters and using a transmission power that is based on the value of the power ramping counter.

A non-transitory computer-readable medium storing code for wireless communication at a UE is described. The code may include instructions executable by a processor to transmit a first set of random access messages of a random access procedure in accordance with a first set of one or more spatial filters, where the first set of random access messages are associated with a first value of a power ramping counter, select a second set of one or more spatial filters based on identifying a failure of the random access procedure, set the power ramping counter to a value based on a comparison of the first set of one or more spatial filters and the second set of one or more spatial filters, and transmit a second set of random access messages associated with a second random access procedure in accordance with the second set of one or more spatial filters and using a transmission power that is based on the value of the power ramping counter.

Some examples of the method, apparatuses, and non-transitory computer-readable medium described herein may further include operations, features, means, or instructions for setting the power ramping counter includes incrementing the power ramping counter to the value based on the first and second sets of one or more spatial filters being the same, or retaining the value of the power ramping counter based on the second set of one or more spatial filters including at least one spatial filter that may be not included within the first set of one or more spatial filters.

In some examples of the method, apparatuses, and non-transitory computer-readable medium described herein, the first set of random access messages may be transmitted via a second transmission power and the method, apparatuses, and non-transitory computer-readable medium may include further operations, features, means, or instructions for transmitting the second set of random access messages via the transmission power that may be greater than the second transmission power based on incrementing the power ramping counter.

In some examples of the method, apparatuses, and non-transitory computer-readable medium described herein, the first set of random access messages may be transmitted via the transmission power and the method, apparatuses, and non-transitory computer-readable medium may include further operations, features, means, or instructions for transmitting the second set of random access messages via the transmission power that may be the same as the transmission power used to transmit the first set of random access messages based on retaining the first value of the power ramping counter.

In some examples of the method, apparatuses, and non-transitory computer-readable medium described herein, the first set of random access messages include repetitions of a first message of the random access procedure and the method, apparatuses, and non-transitory computer-readable medium may include further operations, features, means, or instructions for identifying a failure of the random access procedure based on an absence of a received second message of the random access procedure within a random access response window, an absence of a received fourth message of the random access procedure within the random access response window, an expiration of a contention timer, a contention resolution failing to satisfy a contention resolution threshold, or any combination thereof, where selecting the second set of one or more spatial filters may be based on identifying the failure of the random access procedure.

In some examples of the method, apparatuses, and non-transitory computer-readable medium described herein, the random access procedure includes a four-step random access procedure or a two-step random access procedure.

In some examples of the method, apparatuses, and non-transitory computer-readable medium described herein, the random access procedure includes a four-step random access procedure and the first set of random access messages, the second set of random access messages, or both, include repetitions of a first message of the four-step random access procedure, repetitions of a third message of the random access procedure, or both.

### BRIEF DESCRIPTION OF THE DRAWINGS

FIG. 1 illustrates an example of a wireless communications system that supports techniques for multiple physical random access channel (PRACH) transmissions in accordance with one or more aspects of the present disclosure.

FIG. 2 illustrates an example of a wireless communications system that supports techniques for multiple PRACH transmissions in accordance with aspects of the present disclosure.

FIG. 3 illustrates an example of a resource configuration that supports techniques for multiple PRACH transmissions in accordance with aspects of the present disclosure.

FIG. 4 illustrates an example of a resource configuration that supports techniques for multiple PRACH transmissions in accordance with aspects of the present disclosure.

FIG. 5 illustrates an example of a resource configuration that supports techniques for multiple PRACH transmissions in accordance with aspects of the present disclosure.

FIG. 6 illustrates an example of a process flow that supports techniques for multiple PRACH transmissions in accordance with aspects of the present disclosure.

FIG. 7 illustrates an example of a process flow that supports techniques for multiple PRACH transmissions in accordance with aspects of the present disclosure.

FIGS. 8 and 9 show block diagrams of devices that support techniques for multiple PRACH transmissions in accordance with aspects of the present disclosure.

FIG. 10 shows a block diagram of a communications manager that supports techniques for multiple PRACH transmissions in accordance with aspects of the present disclosure.

FIG. 11 shows a diagram of a system including a device that supports techniques for multiple PRACH transmissions in accordance with aspects of the present disclosure.

FIGS. 12 through 15 show flowcharts illustrating methods that support techniques for multiple PRACH transmissions in accordance with aspects of the present disclosure.

### DETAILED DESCRIPTION

In some wireless communications systems, wireless devices (e.g., user equipments (UEs)) may perform random access channel (RACH) procedures with the network in order to establish wireless connections with the network. RACH procedures may include 2-step or 4-step RACH procedures, in which a UE and the network exchange messages in an alternating “handshaking” manner to establish wireless communications. To begin a RACH procedure, a UE may receive reference signals from the network, where the reference signals are transmitted using different spatial filters (e.g., different beams). In such cases, the UE may perform measurements on the reference signals to determine what spatial filter(s) (what beam(s)) should be used to transmit/receive messages of the RACH procedure. The transmission power for RACH messages may be determined based on the spatial filter that is being used. Additionally, UEs may transmit multiple repetitions of RACH messages in order to increase robustness and improve the probability that the RACH procedure will be successful. However, when transmitting multiple repetitions of a RACH message using different spatial filters, it is unclear how the UE is to determine a Tx power of the RACH repetitions. Additionally, when after transmitting multiple repetitions of a RACH message using different spatial filters, conventional RACH procedures do not define which spatial filter will be used to continue the RACH procedure.

Accordingly, aspects of the present disclosure are directed to signaling and rules for determining transmission powers used for transmitting multiple repetitions of RACH messages, and for determining which spatial filter will be used to perform a RACH message. For example, in accordance with some implementations, aspects of the present disclosure may enable a UE to determine a single transmission power that will be used to transmit multiple repetitions of a RACH message a using different spatial filters. In particular, the UE may select multiple spatial filters that will be used to transmit repetitions of a RACH, determine a single transmission power for the RACH messages based on one of the selected spatial filters, then transmit each of the RACH messages using the same transmission power and the respective spatial filters. In this regard, aspects of the present disclosure may enable UEs to efficiently identify a single transmission power that will be used to transmit RACH messages using multiple spatial filters. As such, techniques described herein may enable the network to expect a single transmission power for multiple repetitions of RACH messages transmitted via different spatial filters, thereby enabling the network to efficiently combine and decode the repetitions of the RACH messages.

Comparatively, in accordance with additional or alternative implementations, the UE may determine a respective transmission power that will be used to transmit each respective RACH message using different spatial filters. In particular, each spatial filter may be associated with a corresponding set of power control parameters. In this regard, upon selecting multiple spatial filters that will be used to transmit repetitions of a RACH message, the UE may determine separate transmission powers for each respective RACH message based on the power control parameters corresponding to the spatial filter associated with each RACH message. As such, techniques described herein may enable spatial filters to be configured with corresponding sets of power control parameters, thereby enabling UEs and the network to efficiently determine transmission powers for RACH messages transmitted using the respective spatial filters. Moreover, configured sets of power control parameters may further enable the network to expect transmission powers for the respective RACH messages in accordance with the configured power control parameters, thereby enabling the network to efficiently combine and decode the repetitions of the RACH messages.

In some implementations, aspects of the present disclosure are directed to rules and configurations for incrementing a power control counter upon re-initiation of a failed RACH procedure, where a value of the power control counter is used to determine a transmission power of RACH messages of the re-initiated RACH procedure. In particular, a UE may be configured to increment the power control parameter (and therefore increase a transmission power of RACH messages) if the UE utilizes the same spatial filter(s) to re-initiate the RACH procedure. Comparatively, a UE may be configured to refrain from incrementing the power control parameter (and therefore maintain a same transmission power of RACH messages) if the UE utilizes at least one new spatial filter to re-initiate the RACH procedure. By either incrementing a power control parameter (and therefore increasing a transmission power of RACH messages) or selecting new spatial filters, techniques described herein may increase a probability that a re-initiated RACH procedure will be successfully completed.

Moreover, some aspects of the present disclosure are directed to rules and signaling which enable the UE to determine which spatial filter will be used to perform the RACH procedure. In particular, after transmitting multiple repetition of a RACH message using multiple spatial filters, the UE will utilize the spatial filter associated with the first RACH message received in response to the RACH repetitions to transmit/receive subsequent RACH messages of the RACH procedure. By enabling rules and signaling which determine which spatial filter will be used to communicate subsequent RACH messages of a RACH procedure (e.g., the spatial filter of the first-received RACH message), techniques described herein may enable UEs and the network to be on the same page with respect to which spatial filters will be used. Moreover, such techniques may enable the network to expect certain spatial filters for subsequent RACH messages, thereby improving an efficiency and reliability of the RACH procedures.

Aspects of the disclosure are initially described in the context of wireless communications systems. Additional aspects of the disclosure are described in the context of example resource configurations and example process flows. Aspects of the disclosure are further illustrated by and described with reference to apparatus diagrams, system diagrams, and flowcharts that relate to techniques for multiple physical random access channel (PRACH) transmissions.

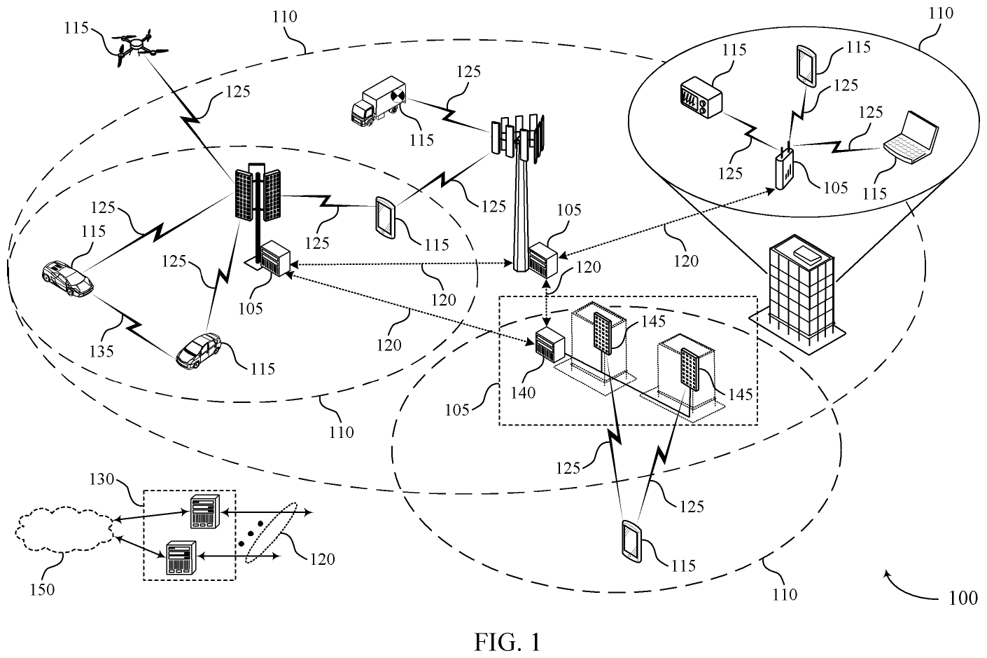

FIG. 1 illustrates an example of a wireless communications system 100 that supports techniques for multiple PRACH transmissions in accordance with one or more aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device/node (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), highest signal-to-interference-plus-noise ratio (SINR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some aspects, the UEs 115 and the base stations 105 of the wireless communications system 100 may be configured to support signaling and rules for determining transmission powers used for transmitting multiple repetitions of RACH messages, and for determining which spatial filter will be used to perform a RACH message.

For example, in accordance with some implementations, a UE 115 of the wireless communications system 100 may be configured to measure reference signals received from the network using multiple spatial filters, and select a set of spatial filters that will be used to transmit RACH messages of a RACH procedure performed with the network. In this example, the UE 115 may determine a single transmission power that will be used to transmit reach repetitions of a RACH message based on one of the selected spatial filters. Subsequently, the UE 115 may transmit multiple repetitions of a RACH message with the respective spatial filters, where each repetition of the RACH message is transmitted via the same determined transmission power.

Comparatively, in accordance with additional or alternative implementations, the UE 115 of the wireless communications system 100 may determine a respective transmission power that will be used to transmit each respective RACH message using different spatial filters. In particular, each spatial filter may be associated with a corresponding set of power control parameters. In this regard, upon selecting multiple spatial filters that will be used to transmit repetitions of the RACH message, the UE 115 may determine separate transmission powers for each respective RACH message based on the power control parameters corresponding to the spatial filter associated with each RACH message.

In some implementations, the wireless communications system 100 may support rules and configurations for incrementing a power control counter upon re-initiation of a failed RACH procedure, where a value of the power control counter is used to determine a transmission power of RACH messages of the re-initiated RACH procedure. For example, the UE 115 may determine that a RACH procedure performed with the network has failed, and may re-initiate the RACH procedure. When re-initiating the RACH procedure, the UE 115 may be configured to increment a power control parameter (and therefore increase a transmission power of retransmitted RACH messages) if the UE 115 utilizes the same spatial filter(s) to re-initiate the RACH procedure. Comparatively, the UE 115 may be configured to refrain from incrementing the power control parameter (and therefore maintain a same transmission power of retransmitted RACH messages) if the UE 115 utilizes at least one new spatial filter to re-initiate the RACH procedure.

Moreover, in some aspects, the wireless communications system 100 is configured to support rules and signaling which enable the UEs 115 to determine which spatial filter will be used to perform a RACH procedure with the network. For example, in some implementations, a UE 115 of the wireless communications system 100 may transmit multiple repetitions of a RACH message using multiple spatial filters. Subsequently, the UE 115 may receive multiple responsive RACH messages from the network, where the responsive RACH messages are transmitted via the same spatial filters as were used by the UE 115. In this example, and in accordance with some aspects of the present disclosure, the UE 115 may be configured to utilize the spatial filter associated with the first responsive RACH message which was received from the network in order to transmit/receive subsequent RACH messages of the RACH procedure. As such, techniques described herein may resolve ambiguity as to what spatial filter should be used to perform RACH procedures in cases where the UE 115 utilizes multiple spatial filters to transmit repetitions of a RACH message.

Techniques described herein may enable UEs 115 and base stations 105 to more efficiently and reliably determine what transmit powers will be used to transmit repetitions of RACH messages associated with RACH procedures performed between the UEs 115 and the network. In this regard, techniques described herein may enable the network (e.g., base stations 105) to expect certain transmission powers of the RACH procedure, combine repetitions of RACH messages, and efficiently decode RACH messages. Moreover, aspects described herein may improve the ability of the network and UEs 115 to perform RACH procedures using multiple spatial filters, which increases redundancy of RACH messages and improves the probability that the RACH procedure will be successful. Further, aspects described herein may enable wireless devices to more efficiently and reliably determine which spatial filter(s) will be used to perform RACH procedures, further improving the reliability of RACH procedures, reducing latency at UEs 115, and improving overall user experience, among other benefits.

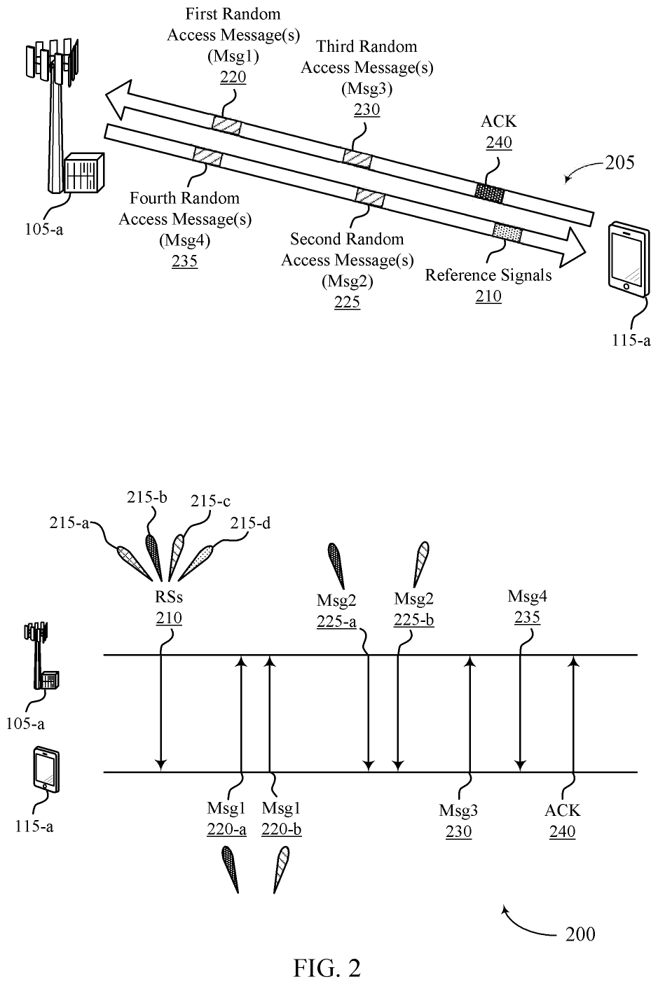

FIG. 2 illustrates an example of a wireless communications system 200 that supports techniques for multiple PRACH transmissions in accordance with aspects of the present disclosure. In some examples, wireless communications system 200 may implement, or be implemented by, aspects of wireless communications system 100. For example, wireless communications system 200 may support signaling and rules which enable the UE 115-a and a network node 105-a (e.g., base station 105-a) to determine transmission powers of RACH messages transmitted via multiple spatial filers, and to determine which spatial filter(s) will be used to transmit/receive messages in random access, as described with reference to FIG. 1.

The wireless communications system 200 may include a network node 105-a, and a UE 115-a, which may be examples network nodes 105 and UEs 115 as described with reference to FIG. 1. The UE 115-a may communicate with the network node 105-a using a communication link 205, which may be an example of an NR or LTE link between the UE 115-a and the network node 105-a. In some cases, the communication link 205 between the UE 115-a and the network node 105-a may include an example of an access link (e.g., Uu link) which may include a bi-directional link that enables both uplink and downlink communication. For example, the UE 115-a may transmit uplink signals, such as uplink control signals or uplink data signals, to the network node 105-a using the communication link 205 and the network node 105-a may transmit downlink signals, such as downlink control signals or downlink data signals, to the UE 115 using the communication link 205.

In some implementations, the UE 115-a may be configured to perform RACH procedures with the network (e.g., network node 105-a) in order to establish wireless connections with the network. RACH procedures may include 2-step or 4-step RACH procedures, in which a UE and the network exchange messages in an alternating “handshaking” manner to establish wireless communications.

To begin a RACH procedure, the UE 115-a may receive reference signals (e.g., synchronization signal block (SSB) signals, CSI-RSs) from the network node 105-a, where the reference signals are transmitted using different spatial filters (e.g., different beams). In such cases, the UE 115-a may perform measurements on the reference signals to determine what spatial filter(s) (what beam(s)) should be used to transmit/receive messages of the RACH procedure. In the context of a 4-step RACH procedure (e.g., Type-1 RACH procedure), the UE 115-a may transmit a first RACH message (e.g., Msg1) via a PRACH channel, where the first RACH message includes a PRACH preamble. The UE 115-a may then receive a second message (e.g., Msg2), or a random access response (RAR) message, via PDCCH, PDSCH, or both, where the second RACH message indicates a timing advance, an uplink grant for a third RACH message (e.g., Msg3 grant), TC-RNTI information, and the like. Subsequently, the UE 115-a may transmit the third RACH message (e.g., Msg3) via PUSCH, where the third RACH message includes an RRC connection request, a scheduling request, buffer status information, and the like. The UE 115-a may then receive a fourth RACH message (e.g., Msg4) via PDCCH and/or PDSCH, where the fourth RACH message includes a contention resolution message. The UE 115-a may complete the RACH procedure by transmitting an ACK responsive to the fourth RACH message, and may communicate with the network node 105-a based on the completion of the RACH procedure.

For Type-1 RACH procedures (e.g., 4-step RACH procedures), the UE 115-a may be provided a number N of SSB and/or physical broadcast channel (PBCH) block indexes associated with one PRACH occasion and a number R of contention-based preambles per SSB/PBCH block index per valid PRACH occasion by ssb-perRACH-OccasionAndCB-PreamblesPerSSB. The SSB index occasions may include transmission occasions where the UE 115-a can expect to receive reference signals from the network node 105-a. For Type-1 RACH procedures, or for Type-2 RACH procedures (e.g., 2-step RACH) with separate configuration of PRACH occasions from Type-1 RACH, if N<1, one SSB/PBCH block index may be mapped to 1/N consecutive valid PRACH occasions and R contention-based preambles with consecutive indexes associated with the SSB/PBCH block index per valid PRACH occasion start from preamble index 0. Comparatively, if N≥1, R contention-based preambles with consecutive indexes associated with SSB/PBCH block index n, 0≤n≤N−1, per valid PRACH occasion start from preamble index n·N_{preamble}^{total}/N, where N_{preamble}^{total} is provided by totalNumberOfRA-Preambles for Type-1 RACH.

In some aspects, SSB/PRACH block indexes provided by ssb-PositionsInBurst in SIB1 or in ServingCellConfigCommon may be mapped to valid PRACH occasions in the following order: (1) in increasing order of preamble indexes within a single PRACH occasion, (2) in increasing order of frequency resource indexes for frequency-multiplexed PRACH occasions, (3) in increasing order of time resource indexes for time-multiplexed PRACH occasions within a PRACH slot, and (4) in increasing order of indexes for PRACH slots.

An association period (e.g., SSB-to-resource association period, starting from frame 0) for mapping SSB/PBCH block indexes to PRACH occasions is the smallest value in the set determined by the PRACH configuration period. Specifically, N_{Tx}^{SSB} SSB/PBCH block indexes may be mapped at least once to the PRACH occasions within the association period, where the UE 115-a obtains N_{Tx}^{SSB} from the value of ssb-PositionsInBurst in SIB1 or in ServingCellConfigCommon. If ere is a set of PRACH occasions or PRACH preambles that are not mapped to N_{Tx}^{SSB} SSB/PBCH block indexes after an integer number of SSB/PBCH block indexes to PRACH occasions mapping cycles within the association period, no SSB/PBCH block indexes are mapped to the set of PRACH occasions or PRACH preambles. An association pattern period includes one or more association periods and is determined so that a pattern between PRACH occasions and SSB/PBCH block indexes repeats at most every 160 ms. PRACH occasions are not associated with SSB/PBCH block indexes after an integer number of association periods, if any, are not used for PRACH transmissions.

As noted previously herein, the UE 115-a may be configured to determine a transmission power that will be used to transmit RACH messages of a RACH procedure performed with the network node 105-a. In some aspects, the UE 115-a may determine a transmission power (P_{PRACH,b,f,c}(i)) for a PRACH on an active uplink BWP (b) of carrier (f) of serving cell (c) based on the downlink reference signal (e.g., SSB, CSI-RS) for serving cell c in transmission occasion i, as determined according to Equation 1 below:

$${P}_{PRACH , b , f , c} ( i ) = min \{ {P}_{CMAC , f , c} ( i ) , {P}_{PRACHtarget , f , c} + {PL}_{b , f , c} \} [ dBm ] \qquad ( 1 )$$

where P_{CMAC,f,c}(i) is the UE-configured maximum output power for carrier f of serving cell c within transmission occasion i, P_{PRACHtarget,f,c} is the PRACH target reception power PREAMBLE_RECEIVED_TARGET_POWER provided by higher layers for the active uplink BWP b of carrier f of serving cell c. P_{PRACHtarget,f,c} may also be associated with (e.g., defined by) preambleReceivedTargetPower (in RRC), plus a delta preamble (e.g., DELTA_PEAMBLE), plus a power ramping counter (e.g., PREAMBLE_POWER_RAMPING_COUNTER−1), multiplied by a power ramping step value (e.g., PREAMBLE_POWER_RAMPING_STEP).

Lastly, PL_{b,f,c} is a pathloss metric for the active uplink BWP b of carrier f based on the downlink reference signal associated with the PRACH transmission on the active downlink BWP on serving cell c. In some cases, the UE 115-a may calculate PL_{b,f,c} for reference signals received from the network node 105-a in dB as referenceSignalPower, higher-layer filtered reference signal received power (RSRP) in dBm, where RSRP is the higher layer filter configuration. If the active downlink BWP is the initial BWP and for SSB/PBCH block and CORESET multiplexing pattern 2 or 3, the UE determines PL_{b,f,c} based on the SSB/PBCH block associated with the PRACH transmission.

Stated differently, the UE 115-a may determine a transmission power for a respective spatial filter/beam based on a downlink reference signal received from the network node 105-a which is associated with the corresponding spatial filter/beam. For example, the UE 115-a may receive, from the network node 105-a, a first reference signal associated with a first spatial filter, and a second reference signal associated with a second spatial filter. In this example, the UE 115-a may determine a first pathloss metric (e.g., PL_{1,b,f,c}) and a second pathloss metric (e.g., PL_{2,b,f,c}) associated with the first and second reference signals, respectively. The UE 115-a may then determine a first transmission power (e.g., P_{PRACH1,b,f,c}) and a second transmission power (e.g., P_{PRACH2,b,f,c}) which will be used to transmit RACH messages using the first and second spatial filters, respectively.

Accordingly, in the context of a 4-step RACH procedure, the UE 115-a may receive reference signals (e.g., SSBs, CSI-RS), where a resource occasion configuration for reference signals (e.g., SSB-RO mapping configuration) is configured via SIB. The UE 115-b may then receive reference signals transmitted via different beams/spatial filters, perform measurements for the received reference signals (e.g., determines pathloss metrics for each spatial filter/beam), and select one or more spatial filters that will be used to transmit PRACH (e.g., Msg1) of the 4-step RACH procedure. In other words, the UE 115-a chooses a set of reference signals (e.g., SSBs)/spatial filters based on the corresponding RSRP of the respective reference signals, and selects the PRACH resource which associates with the chosen SSB (e.g., selects spatial filters, then transmits Msg1 within resources associated with the selected spatial filters). The UE 115-a then transmits PRACH (e.g., repetitions of Msg1) using the spatial filter associated with the chosen SSB. If a PRACH (e.g., repetition of Msg1) is received by the network node 105-a, the network node 105-a will use the same beam/same spatial filter for the transmission of Msg2 (PDCCH/PDSCH) and Msg4 (PDCCH/PDSCH) of the RACH procedure. Subsequently, the UE 115-a may transmit Msg3 (PUSCH) using the same spatial filter that the UE 115-a used to transmit PRACH and/or the same spatial filter that was used for Msg2.

According to some techniques for performing RACH procedures, the path loss calculation is based on the downlink reference signal associated with PRACH transmission on an active downlink BWP. If the active downlink BWP is the initial downlink BWP, the UE 115-a determines pathloss metrics(s) for received reference signals based on the SSB/PBCH block associated with the PRACH transmission. In other words, the UE 115-a determines pathloss metrics for each respective beam/spatial filter based on measurements performed on reference signals transmitted in accordance with the respective beams/spatial filters. Otherwise, downlink reference signals may be RRC configured. For multiple PRACH transmissions with different spatial domain filters (e.g., when the UE 115-a transmits multiple repetitions of Msg1), different PRACH transmissions may be associated with different downlink reference signals associated with different spatial filters. That is, a UE 115-a may transmit multiple repetitions of Msg1 of a RACH procedure via multiple spatial filters.

In some implementations, the UE 115-a (and the network node 105-a) may transmit multiple repetitions of RACH messages using different spatial filters to improve signaling diversity, increase robustness, and improve the likelihood that RACH messages will be successfully received. However, as noted previously herein, the transmission power of RACH messages may be determined based on the spatial filter that will be used for the respective RACH messages. As such, when transmitting multiple repetitions of a RACH message using different spatial filters, it is unclear how the UE 115-a is to determine a transmit (Tx) power of the RACH repetitions. That is, some RACH techniques are not clear as to how the UE 115-a is to determine a Tx power for multiple repetitions of a RACH message when the RACH repetitions are transmitted via different spatial filters. Additionally, after transmitting multiple repetitions of a RACH message using different spatial filters, conventional RACH procedures do not define which spatial filter will be used to continue the RACH procedure. Taken together, the use of multiple spatial filters when performing RACH procedures can result in confusion and indefiniteness that is not addressed using some conventional RACH techniques.

Accordingly, the UE 115-a and the network node 105-a of the wireless communications system 200 may be configured to support signaling and rules for determining transmission powers used for transmitting multiple repetitions of RACH messages, and for determining which spatial filter will be used to perform a RACH message. In other words, aspects of the present disclosure may be used to determine what transmission power(s) should be used for transmitting multiple repetitions of a RACH message via multiple spatial filters, and what spatial filter should be used to complete the RACH procedure.

For example, as shown in FIG. 2, the network node 105-a may transmit reference signals 210 to the UE 115-a. The reference signals 210 may include SSB messages, CSI-RSs, or both. In some implementations, the network node 105-a may transmit the reference signals 210 using (e.g., in accordance with) multiple beams or spatial filters 215. For example, as shown in FIG. 2, the network node 105-a may transmit a set of reference signals 210 using multiple spatial filters 215 (e.g., multiple beams), including a first spatial filter 215-a, a second spatial filter 215-b, a third spatial filter 215-c, and a fourth spatial filter 215-d.

The UE 115-a may be configured to perform measurements on the received reference signals 210. In particular, the UE 115-a may be configured to perform measurements on the received reference signals 210 in order to determine what spatial filter(s) 215 will be used to perform communications associated with a random access procedure (e.g., RACH procedure) with the network node 105-a. In this regard, the UE 115-a may be configured to perform measurements on the received reference signals 210 in order to determine characteristics (e.g., performance) of the respective spatial filters 215. Measurements performed on the received reference signals 210 (e.g., characteristics of the respective spatial filters 215) may include RSRP measurements, reference signal received quality (RSRQ) measurements, SNR measurements, SINR measurements, channel quality indicator (CQI) measurements, pathloss measurements, or any combination thereof.

In some aspects, the UE 115-a may be configured to select one or more spatial filters 215 that will be used to transmit a first random access message 220 (e.g., Msg1) of a random access procedure. In particular, the UE 115-a may select one or more spatial filters 215 that will be used to transmit a first random access message 220 based on the measurements performed on the reference signals 210. In other words, the UE 115-a may select one or more spatial filters 215 that will be used to transmit Msg1 of a RACH procedure based on characteristics of the respective spatial filters 215. For example, in some cases, the UE 115-a may select one or more spatial filters 215 which exhibit the highest RSRP measurements out of all the spatial filters 215. In this regard, the UE 115-a may select one or more spatial filters 215 by comparing RSRP measurements of the respective spatial filters 215 to some threshold RSRP value, comparing the RSRP measurements of the respective spatial filters 215 to one another, or both. For instance, as shown in FIG. 2, the UE 115-a may select the second spatial filter 215-b and the third spatial filter 215-c based on the second and third spatial filters 215-b, 215-c exhibiting the highest RSRP measurements out of all the spatial filters 215 used to transmit/receive the reference signals 210.

In some implementations, the UE 115-a may transmit one or more repetitions of a first random access message 220 based on (e.g., using) the selected spatial filters 215. For example, in the context of a four-step RACH procedure illustrated in FIG. 2, the UE 115-a may transmit a first repetition of the first random access message 220-a (e.g., first repetition of Msg1) using the second spatial filter 215-b, and may transmit a second repetition of the first random access message 220-b (e.g., second repetition of Msg1) using the third spatial filter 215-c.

As noted previously herein, using some PRACH techniques, if a PRACH transmission (e.g., repetition of the first random access message 220) is associated with downlink reference signal 210 k, the PRACH transmission power is determined based on downlink reference signal 210 k. However, the path loss may be different for different downlink reference signals 210, resulting in PRACH transmissions with different spatial filters 215 being transmitted with different transmit powers. In such cases, the different transmit powers may be unknown to the network node 105-a, and the network node 105-a may not be able to properly combine multiple PRACH transmissions across different beams/spatial filters 215.

Accordingly, in accordance with some implementations of the present disclosure, the UE 115-a may be configured to compute a single transmission power that will be used to transmit the multiple repetitions of the first random access message 220 using multiple spatial filters 215. In other words, if the UE 115-a performs multiple PRACH transmissions (e.g., repetitions of the first random access message 220-a, 220-b) with different spatial filters 215, the UE 115-a may be configured to compute a single PRACH transmission power based on a downlink reference signal 210 associated with one spatial filter 215. In such cases, it may be up to the UE 115-a to select a suitable spatial filter 215 that will be used to transmit PRACH transmissions and to compute the PRACH transmission power. Moreover, in such cases, the determined transmission power may be applied to PRACH transmissions regardless of the associated spatial filters 215.

For example, as shown in FIG. 2, the UE 115-a may select the second spatial filter 215-b and the third spatial filter 215-c to transmit repetitions of the first random access message 220-a, 220-b. In this example, the UE 115-a may determine a single transmission power that will be used to transmit both repetitions of the first random access message 220-b, 220-b, where the single transmission power is based on one of the second spatial filter 215-b or the third spatial filter 215-c (e.g., the single transmission power is based on any one of the spatial filters used to actually transmit the repetitions of the first random access message). In other words, the single spatial filter used to determine the single transmission power may be selected from among a group of spatial filters used (or to be used) to transmit the repetitions of the first random access message. Alternatively, the single spatial filter used to determine the single transmission power may be selected from among a group of available spatial filters (e.g., spatial filters 215-a through 215-d) that are usable to transmit a repetition of the first random access message (even if that spatial filter is not actually used to transmit a repetition). The UE 115-a may select which spatial filter 215 will be used to determine the transmission power based on any characteristic or parameter associated with the respective spatial filters 215-b, 215-c, including pathloss metrics, RSRP measurements, and the like. For instance, the UE 115-a may determine a transmission power based on the second spatial filter 215-b based on the second spatial filter 215-b exhibiting a higher or lower pathloss metric as compared to the third spatial filter 215-c.

In some implementations, the UE 115-a may be configured (e.g., pre-configured, configured via control signaling from the network node 105-a) with parameters for selecting which spatial filter(s) 215 will be used to select which spatial filter(s) 215 will be used to transmit the first random access messages 220, parameters for selecting which spatial filter 215 will be used to determine the transmission power for the first random access messages 220, or both. For example, the UE 115-a may receive control signaling from the network node 105-a, where the control signaling configures the UE 115-a to select the spatial filters 215 with the highest RSRP as the spatial filters used to transmit the first random access message 220. By way of another example, the UE 115-a may receive control signaling from the network node 105-a, where the control signaling configures the UE 115-a to utilize the spatial filter 215 with the highest or lowest pathloss metric as the spatial filter that will be used to determine the transmission power for the first random access message 220.

In some aspects, by transmitting the repetitions of the first random access message 220-a, 220-b with a same/common transmission power, the network node 105-a may be able to determine/expect the used transmission power, and may be able to more efficiently combine the repetitions of the first random access message 220-a, 220-b across the respective spatial filters 215-b, 215-c. As such, techniques described herein may improve an efficiency and reliability of random access procedures.

In additional or alternative implementations, the UE 115-a may be configured to determine separate (e.g., different, independent) transmission powers for each respective repetition of the first random access message 220-a, 220-b. In other words, if the baseline PRACH power control is used for multiple PRACH transmissions (e.g., different repetitions of the first random access message 220) with different spatial filters 215, the UE 115-a may be configured with different PRACH power control parameters for PRACH transmissions associated with different spatial filters 215. Stated differently, each respective spatial filter 215 may be associated with a different set of power control parameters, and the UE 115-a may utilize the respective power control parameters corresponding to the respective spatial filters 215 to determine transmission powers that will be used for each repetition of the first random access message 220-a, 220-b.

For example, the UE 115-a may receive, from the network node 105-a, control signaling (e.g., RRC signaling, SIB messaging (SIB1)) that indicates a set of power control parameters for each respective spatial filter 215. For instance, the control signaling may indicate a first set of power control parameters associated with the first spatial filter 215-a, a second set of power control parameters associated with the second spatial filter 215-b, a third set of power control parameters associated with the third spatial filter 215-c, and a fourth set of power control parameters associated with the fourth spatial filter 215-d. The respective sets of power control parameters may include, but are not limited to, a preamble received target power parameter (e.g., preambleReceivedTargetPower), a maximum transmission parameter (e.g., preambleTransMax), a power ramping step parameter (e.g., powerRampingStep), and the like.

Continuing with the same example, upon selecting the second spatial filter 215-b and the third spatial filter 215-c for transmitting Msg1, the UE 115-a may determine a first transmission power for transmitting the first repetition of the first random access message 220-a based on (e.g., using) the second set of power control parameters associated with the second spatial filter 215-b. Moreover, the UE 115-a may determine the first transmission power for the first repetition of the first random access message 220-a based on measurements performed on reference signal(s) 210 received via the second spatial filter 215-b. Similarly, the UE 115-a may determine a second transmission power for transmitting the second repetition of the first random access message 220-b based on (e.g., using) the third set of power control parameters associated with the third spatial filter 215-b and measurements performed on reference signals 210 received via the third spatial filter 215-c. Subsequently, the UE 115-a may transmit the first repetition of the first random access message 220-a using (e.g., in accordance with) the first determined transmission power, and may transmit the second repetition of the first random access message 220-b using the second determined transmission power. In such cases, the first and second transmission powers may be the same or different.

In some aspects, upon transmitting one or more repetitions of the first random access message 220 in accordance with one or more spatial filters 215, the UE 115-a may be configured to monitor for one or more repetitions of a second random access message 225 (e.g., RAR messages, repetitions of Msg2). In particular, the UE 115-a may monitor for repetitions of Msg2 that are transmitted via the same spatial filters 215 as were used to transmit the repetitions of Msg1. In other words, for multiple PRACH transmissions (e.g., repetitions of the first random access message 220) with different spatial filters 215 (e.g., spatial domain filters), the UE 115-a monitors Msg2 PDCCH and receive Msg2 PDSCH using spatial filters 215 associated with the downlink reference signals 210 associated with the spatial filters 215 used to perform the PRACH transmissions (e.g., spatial filters 215 used to transmit Msg1).

For example, upon transmitting the first and second repetitions of the first random access message 220-a, 220-b via the second and third spatial filters 215-b, 215-c, respectively, the UE 115-a may monitor for RAR messages (e.g., repetitions of Msg2, repetitions of the second random access message 225) associated with (or transmitted via) the second and third spatial filters 215-b, 215-c.

In such cases with multiple PRACH transmissions with different spatial filters 215, aspects of the present disclosure are directed to rules and configurations that clarify which spatial filter 215 the UE 115-a should use to receive Msg2/Msg4 PDCCH/PDSCH, and transmit Msg3 PUSCH. In other words, in cases where the UE 115-a transmits multiple repetitions of Msg1 via multiple spatial filters 215, and therefore receives multiple repetitions of Msg2 via multiple spatial filters 215, aspects of the present disclosure may provide rules and configurations which enable the UE 115-a to determine which spatial filter(s) 215 will be used to perform subsequent communications of the random access procedure.

In some implementations, the UE 115-a may be configured to use the spatial filter 215 associated with the first successfully received repetition of the second random access message 225 to perform subsequent communications of the random access procedure. Moreover, the UE 115-a may be configured to stop monitoring for repetitions of Msg2 (e.g., stop Msg2 reception) once a correct Msg2 is successfully received. In such cases, the UE 115-a may use the spatial filter 215 (e.g., spatial Rx filter) that was used to successfully receive Msg2 to receive Msg4 PDCCH/PDSCH. Further, the UE 115-a may use the spatial filter 215 associated with the downlink reference signal 210 that is associated with the spatial filter 215 used to successfully receive Msg2 to transmit Msg3 PUSCH.

For example, in some cases, the UE 115-a may receive the repetition of the second random access message 225-a (e.g., Msg2) associated with the second spatial filter 215-b. In this example, upon successfully receiving the repetition of the second random access message 225-a, the UE 115-a may stop monitoring for additional repetitions of Msg2, and may utilize the second spatial filter 215-b to transmit a third random access message 230 (e.g., Msg3), receive a fourth random access message 235 (e.g., Msg4) or both.

Comparatively, by way of another example, the UE 115-a may not successfully receive the repetition of the second random access message 225-a (e.g., Msg2) associated with the second spatial filter 215-b, and may instead successfully receive the repetition of the second random access message 225-b (e.g., Msg2) associated with the third spatial filter 215-c. In this example, upon successfully receiving the repetition of the second random access message 225-b, the UE 115-a may stop monitoring for additional repetitions of Msg2, and may utilize the third spatial filter 215-c to transmit the third random access message 230 (e.g., Msg3), receive the fourth random access message 235 (e.g., Msg4) or both.

In this regard, the UE 115-a may utilize the spatial filter 215 associated with the first successfully received repetition of Msg2 to perform subsequent communications of the random access procedure. As such, aspects of the present disclosure may resolve ambiguity as to which spatial filter 215 is to be used to perform random access procedures in cases where multiple spatial filters 215 are used for performing PRACH transmissions. Thus, techniques described herein may enable the UE 115-a and the network node 105-a to be on the same page as to which spatial filter 215 will be used to transmit/receive Msg3 and Msg4 of the four-step random access procedure.

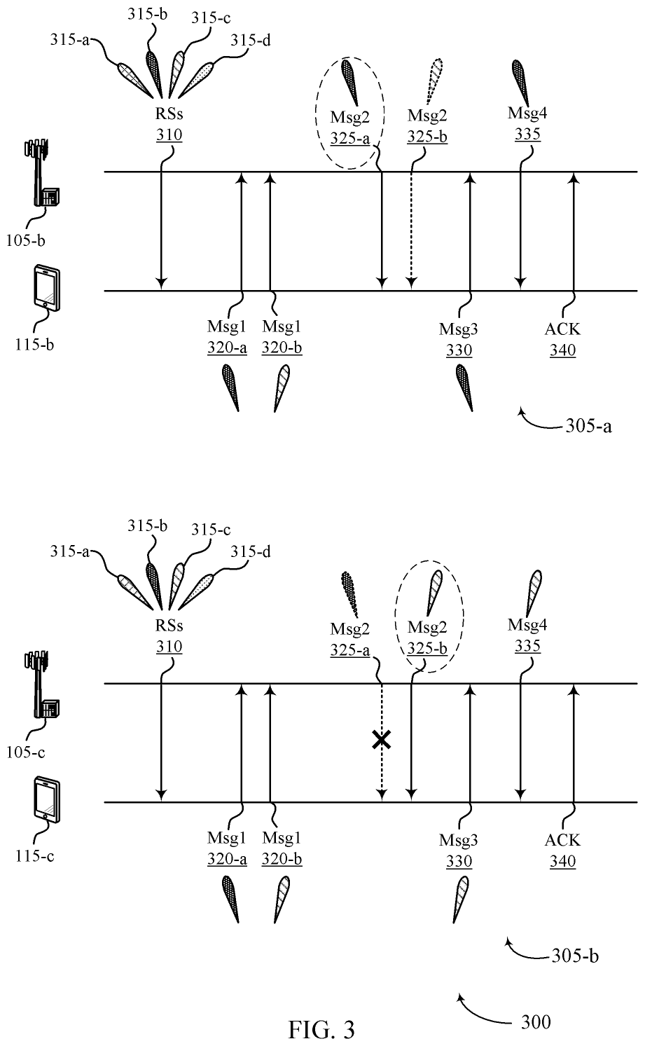

The selection of which spatial filter 215 will be used to perform Msg3 and Msg4 of a four-step RACH procedure will be further shown and described with reference to FIG. 3.

Continuing with reference to FIG. 2, upon successfully receiving a repetition of Msg2 (e.g., second random access message 225, the UE 115-a may transmit the third random access message 230 to the network node 105-a using the spatial filter 215 that was used to successfully receive the second random access message 225 (e.g., second spatial filter 215-b or third spatial filter 215-c). Subsequently, the UE 115-a may receive the fourth random access message 235 via the same spatial filter 215 that was used to receive the second random access message 225 and transmit the third random access message 230 (e.g., second spatial filter 215-b or third spatial filter 215-c). In this regard, the UE 115-a and the network node 105-a may complete the random access procedure, and the UE 115-a may transmit a feedback message (e.g., ACK message 240) based on receiving the fourth random access message 235 and completing the RACH procedure. The UE 115-a and the network node 105-a may then communicate with one another based on transmitting/receiving the ACK message 240 and completing the RACH procedure.

In some cases, a RACH procedure between the UE 115-a and the network node 105-a may fail. In such cases, the wireless devices may be configured to re-initiate the RACH procedure. In particular, if the RACH procedure illustrated in FIG. 2 fails at Msg2 or Msg4, the UE 115-a may be configured to retransmit Msg1 in order to re-initiate the RACH procedure.

In this regard, the UE 115-a may be configured to trigger PRACH retransmission in the event the RACH procedure fails. In accordance with some aspects of the present disclosure, the UE 115-a may be configured to increment (or refrain from incrementing) a power control counter (e.g., PREAMBLE_POWER_RAMPING_COUNTER) based on the spatial filters 215 used to re-initiate the RACH procedure, where the power ramping counter is used to determine a transmission power of the transmitted random access messages. In this regard, the UE 115-a may be configured to retain or increase the transmission power used to transmit random access messages 220, 230 (e.g., increment or retain a value of the power ramping counter) depending on what spatial filters 215 are used to re-initiate the RACH procedure.

In some aspects, the power ramping counter (e.g., PREAMBLE_POWER_RAMPING_COUNTER) is same for all repetitions of the first random access message 220 transmitted during a RACH procedure. Moreover, When the RACH procedure is initiated on a serving cell (e.g., serving cell supported by network node 105-a), the MAC entity (e.g., UE 115-a) may be configured to set a preamble transmission counter (e.g., PREAMBLE_TRANSMISSION_COUNTER) to 1 (e.g., M=1), and set the power ramping counter to 1 (e.g., N=1) for preamble transmission counter=N, where N<M and M is the configured number of PRACH repetitions. For example, as shown in FIG. 2, the UE 115-a may transmit multiple repetitions of Msg1 via the second spatial filter 215-b and the third spatial filter 215-c, where the power ramping counter is set to 1 (N=1) and the preamble transmission counter is incremented to 2 (M=2) for the two repetitions of Msg1.

In this example, the UE 115-a, the network node 105-a, or both, may be configured to identify a failure of the RACH procedure. The RACH procedure may fail when Msg2 and/or Msg4 is not received within some time interval (e.g., within a RAR window), when a contention resolution timer (e.g., ra-ContentionResolutionTimer) expires, when a contention resolution fails, or any combination thereof. For example, the UE 115-a may be configured to identify a failure of the RACH procedure based on identifying an absence of the second random access message 225 (e.g., Msg2) within a RAR window, an absence of the fourth random access message 235 (e.g., Msg4) within a RAR window, an expiration of a contention timer (e.g., ra-ContentionResolutionTimer), a contention resolution failing to satisfy a contention resolution threshold, or any combination thereof.

Accordingly, upon identifying a failure of the RACH procedure, the UE 115-a may be configured to re-initiate the RACH procedure (e.g., start a new RACH procedure) by retransmitting one or more repetitions of the first random access message 225. In such cases, if the UE 115-a utilizes the same set of spatial filters 215 to perform the retransmissions of Msg1 (e.g., if the UE 115-a utilizes the second spatial filter 215-b and/or the third spatial filter 215-c), the UE 115-a may be configured to increment the power ramping counter (e.g., increment to N=2) for the retransmissions of Msg1. As such, by incrementing the power ramping counter, the UE 115-a may be configured to increase the transmission power of the Msg1 retransmissions. Conversely, if the UE 115-a utilizes at least one different spatial filter 215 to perform the retransmissions of Msg1, the UE 115-b may be configured to retain the value of the same power ramping counter. As such, by retaining the same power ramping counter value, the UE 115-a may be configured to use the same transmission power to perform the Msg1 retransmissions.

Stated differently, the UE 115-a may be configured to increment the power ramping counter by 1 for

$$M * floor ( \frac{N}{M} ) + 1 \leq N \leq M * floor ( \frac{N}{M} ) + M$$

only if the selected spatial filter(s) 215 (e.g., selected SSB or CSI-RS) for

$$M * floor ( \frac{N}{M} ) + 1 \leq N \leq M * floor ( \frac{N}{M} ) + M$$

are completely the same as the spatial filters 215 used for the initial transmissions of the first random access message 220-a, 220-b. Conversely, if the UE 115-a changes at least one of the spatial filter 215 to perform the Msg1 retransmissions, Layer 1 at the UE 115-a may notify higher layers to suspend the power ramping counter for

$$M * floor ( \frac{N}{M} ) + 1 \leq N \leq M * floor ( \frac{N}{M} ) + M$$

(e.g., notify higher layers to refrain from incrementing the power ramping counter).

In this regard, upon re-initiating the RACH procedure, the UE 115-a may be configured to increase a probability that the re-initiated RACH procedure will be successful by (1) using different spatial filters 215 (keeping same power ramping counter value and therefore using the same transmission power), or (2) using the same spatial filters 215, but incrementing the power ramping counter value and therefore increasing the transmission power.

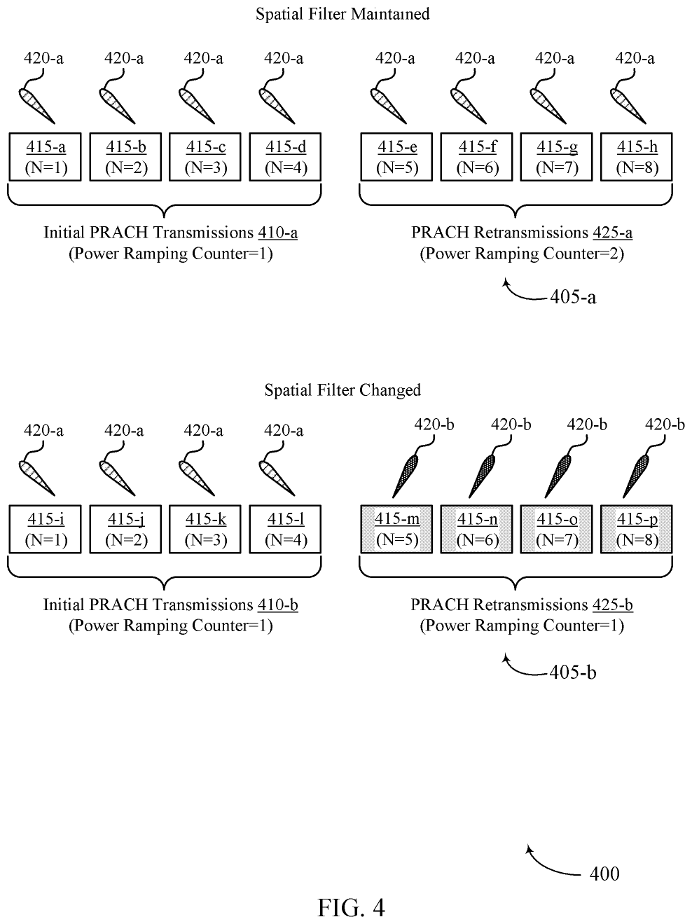

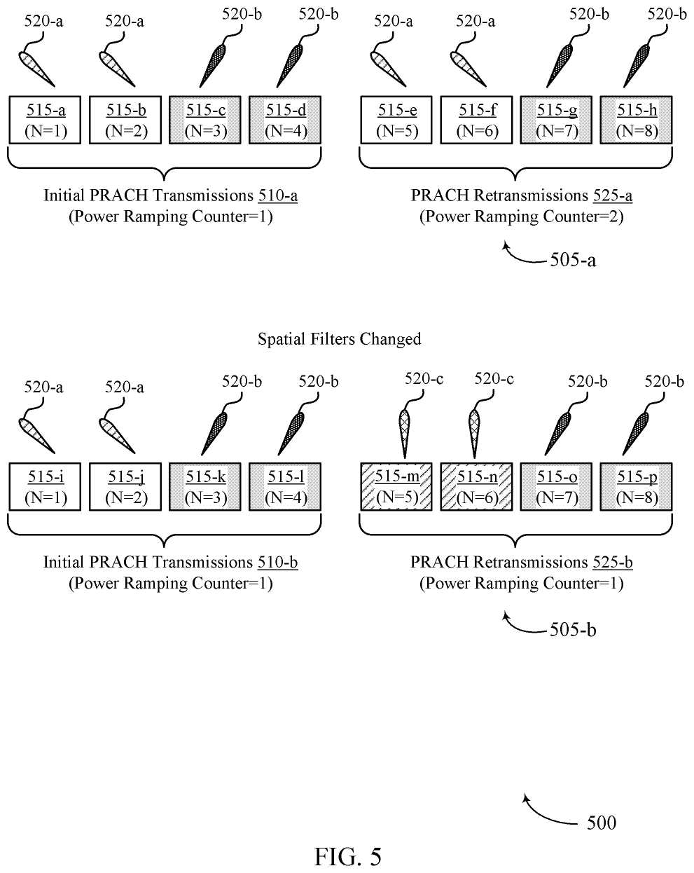

Procedures for setting a value of the power ramping counter upon re-initiating a RACH procedure will be further shown and described with reference to FIGS. 4-5.

FIG. 3 illustrates an example of a resource configuration 300 that supports techniques for multiple PRACH transmissions in accordance with aspects of the present disclosure. Aspects of the resource configuration 300 may implement, or be implemented by, aspects of the wireless communications system 100, the wireless communications system 200, or both.

In particular, resource configuration 300 illustrates RACH procedures 305-a, 305-b in which a UE 115 transmits multiple repetitions of a RACH message using multiple spatial filters 315, and selects which spatial filter 315 will be used to perform subsequent communications of the respective RACH procedures 305, as described previously herein.

For example, referring to the first RACH procedure 305-a, a network node 105-b may transmit reference signals 310 to a UE 115-b. The reference signals 310 may include SSB messages, CSI-RSs, or both. In some implementations, the network node 105-b may transmit the reference signals 310 using (e.g., in accordance with) multiple beams or spatial filters 315. For example, the network node 105-b may transmit a set of reference signals 310 using multiple spatial filters 315 (e.g., multiple beams), including a first spatial filter 315-a (SSB #1), a second spatial filter 315-b (SSB #2), a third spatial filter 315-c (SSB #3), and a fourth spatial filter 315-d (SSB #4).

The UE 115-b may be configured to perform measurements on the received reference signals 310. In particular, the UE 115-b may be configured to perform measurements on the received reference signals 310 in order to determine what spatial filter(s) 315 will be used to perform communications associated with RACH procedure 305-a. In this regard, the UE 115-b may be configured to perform measurements on the received reference signals 310 in order to determine characteristics (e.g., performance) of the respective spatial filters 315. Measurements performed on the received reference signals 210 (e.g., characteristics of the respective spatial filters 315) may include RSRP measurements, reference signal received quality (RSRQ) measurements, SNR measurements, SINR measurements, channel quality indicator (CQI) measurements, pathloss measurements, or any combination thereof.

In this example, the UE 115-b may select the second spatial filter 315-b and the third spatial filter 315-c, for example, based on comparing RSRP values associated with the respective spatial filters 315 to one another, to threshold RSRP values, or both. The UE 115-b may then transmit a first repetition of Msg1 320-a using the second spatial filter 315-b, and may transmit a second repetition of Msg1 320-b using the third spatial filter 315-c. The UE 115-b may then monitor for repetitions of Msg2 transmitted via the second and third spatial filters 315-b, 315-c.

As noted previously herein, the UE 115-b may be configured to utilize the spatial filter 315 associated with the first-received repetition of Msg2 to transmit Msg3, receive Msg4 335, or both. For example, continuing with reference to the first RACH procedure 305-a, the UE 115-b may successfully receive a first repetition of Msg2 325-a associated with the second spatial filter 315-b. In this example, the UE 115-b may stop monitoring for subsequent repetitions of Msg2 325. Thus, even if the network node 105-b transmits the second repetition of Msg2 325-b, the UE 115-a may not successfully receive and/or decode the second repetition of Msg2 325-b. In this example, the UE 115-b may utilize the second spatial filter 315-b to transmit Msg3 330 and receive Msg4 335. The UE 115-b may then transmit an ACK message 340 based on receiving Msg4 335, and may communicate with the network node 105-b based on completing the RACH procedure 305-a and/or transmitting the ACK message 340.

Reference will now be made to the second RACH procedure 305-b. As noted previously herein, a network node 105-c may transmit reference signals 310 to a UE 115-c. The reference signals 310 may include SSB messages, CSI-RSs, or both. In some implementations, the network node 105-c may transmit the reference signals 310 using (e.g., in accordance with) multiple beams or spatial filters 315, including a first spatial filter 315-a (SSB #1), a second spatial filter 315-b (SSB #2), a third spatial filter 315-c (SSB #3), and a fourth spatial filter 315-d (SSB #4). The UE 115-c may be configured to perform measurements on the received reference signals 310. In particular, the UE 115-c may be configured to perform measurements on the received reference signals 310 in order to determine what spatial filter(s) 315 will be used to perform communications associated with RACH procedure 305-a.

In this example, the UE 115-c may again select the second spatial filter 315-b and the third spatial filter 315-c, for example, based on comparing RSRP values associated with the respective spatial filters 315 to one another, to threshold RSRP values, or both. The UE 115-c may then transmit a first repetition of Msg1 320-a using the second spatial filter 315-b, and may transmit a second repetition of Msg1 320-b using the third spatial filter 315-c. The UE 115-c may then monitor for repetitions of Msg2 transmitted via the second and third spatial filters 315-b, 315-c.

In this example, as shown in the second RACH procedure 305-b, the network node 105-c may not transmit (or the UE 115-c may not successfully receive) the repetition of Msg2 325-a associated with the second spatial filter 315-b. In this regard, the UE 115-c may successfully receive and decode the repetition of Msg2 325-b associated with the third spatial filter 315-c, and may refrain from monitoring for additional repetitions of Msg2 325. In this example, the UE 115-c may utilize the third spatial filter 315-c to transmit Msg3 330 and receive Msg4 335. The UE 115-c may then transmit an ACK message 340 based on receiving Msg4 335, and may communicate with the network node 105-c based on completing the RACH procedure 305-b and/or transmitting the ACK message 340.

FIG. 4 illustrates an example of a resource configuration 400 that supports techniques for multiple PRACH transmissions in accordance with aspects of the present disclosure. Aspects of the resource configuration 400 may implement, or be implemented by, aspects of the wireless communications system 100, the wireless communications system 200, resource configuration 300, or any combination thereof.

The resource configuration 400 illustrates RACH procedures 405-a, 405-b in which a UE 115 identifies a failure of the respective RACH procedure 405, re-initiates the RACH procedure 405, and sets a value of a power ramping counter based on the spatial filters used to re-initiate the RACH procedure 405, as described previously herein. In particular, the first RACH procedure 405-a illustrates a case in which a UE 115 maintains the same spatial filter to re-initiate the RACH procedure 405-a, and therefore increments a power ramping counter. Comparatively, the second RACH procedure 405-b illustrates a case in which a UE 115 changes the spatial filter used to re-initiate the RACH procedure 405-b, and therefore refrains from incrementing the power ramping counter (e.g., retains the same value of the power ramping counter).

For example, referring to the first RACH procedure 405-a, a UE 115 may transmit an initial set of PRACH transmissions 410-a of the PRACH procedure 405-a. The PRACH transmissions 415-a, 415-b, 415-c, and 415-d may include examples of repetitions of Msg1 and/or Msg3, where the UE 115 increments a preamble transmission counter N (e.g., repetition counter) for each PRACH transmission 415. For example, as shown in FIG. 4, the UE 115 may set the repetition counter N=1 for the first PRACH transmission 415-a, N=2 for the second PRACH transmission 415-b, N=3 for the third PRACH transmission 415-c, and N=4 for the fourth PRACH transmission 415-d.

In some aspects, the UE 115 may transmit the initial set of PRACH transmissions 410-a (e.g., PRACH transmissions 415-a, 415-b, 415-c, 415-d) using a first spatial filter 420-a. The first spatial filter 420-a may be associated with a reference signal (e.g., SSB) received from a network node 105. For instance, the first spatial filter 420-a may correspond to SSB #0. The UE 115 may set a power ramping counter to 1 for each of the PRACH transmissions 415-a through 415-d (e.g., PREAMBLE_POWER_RAMPING_COUNTER=1 for N=1, . . . 4).

Subsequently, the UE 115 may identify a failure of the RACH procedure 405-a, and may therefore re-initiate the RACH procedure 405-a by transmitting a set of PRACH retransmissions 425-a. The PRACH transmissions 415-e, 415-f, 415-g, and 415-h may include examples of repetitions of Msg1 and/or Msg3, where the UE 115 increments a preamble transmission counter N (e.g., repetition counter) for each PRACH transmission 415, including the PRACH transmissions 415 included in the initial set of PRACH transmissions 410-a. For example, as shown in FIG. 4, the UE 115 may set the repetition counter N=5 for the PRACH transmission 415-e, N=6 for the PRACH transmission 415-f, N=7 for the PRACH transmission 415-g, and N=8 for the PRACH transmission 415-h.

In this example, the UE 115 may transmit the set of PRACH retransmissions 425-a using the same spatial filter 420 (e.g., first spatial filter 420-a) as was used to transmit the initial set of PRACH transmissions 410-a. In this regard, the spatial filters 420 for retransmission (e.g., used to re-initiate the RACH procedure 405-a) are completely the same as initial transmission. Accordingly, the UE 115 may increment the power ramping counter based on using the same spatial filter 420-a for retransmission. In other words, the UE 115 may increment PREAMBLE_POWER_RAMPING_COUNTER by 1 (e.g., preamble ramping counter=2) for each PRACH transmission 415 of the set of PRACH retransmissions 425-a. In this regard, the UE 115 may increase a transmission power used to transmit the set of PRACH retransmissions 425-a relative to the transmission power used to transmit the initial PRACH transmissions 410-a based on incrementing the power ramping counter.

Reference will now be made to the second RACH procedure 405-b. As described previously, a UE 115 may transmit an initial set of PRACH transmissions 410-b of the PRACH procedure 405-b. The PRACH transmissions 415-i, 415-j, 415-k, and 415-l may include examples of repetitions of Msg1 and/or Msg3, where the UE 115 increments a preamble transmission counter N (e.g., repetition counter) for each PRACH transmission 415. For example, as shown in FIG. 4, the UE 115 may set the repetition counter N=1 for the first PRACH transmission 415-i, N=2 for the second PRACH transmission 415-j, N=3 for the third PRACH transmission 415-k, and N=4 for the fourth PRACH transmission 415-l.

In some aspects, the UE 115 may transmit the initial set of PRACH transmissions 410-b (e.g., PRACH transmissions 415-i, 415-j, 415-k, 415-l) using a first spatial filter 420-a. The first spatial filter 420-a may be associated with a reference signal (e.g., SSB) received from a network node 105. For instance, the first spatial filter 420-a may correspond to SSB #0. The UE 115 may set a power ramping counter to 1 for each of the PRACH transmissions 415-i through 415-l (e.g., PREAMBLE_POWER_RAMPING_COUNTER=1 for N=1, . . . 4).

Subsequently, the UE 115 may identify a failure of the RACH procedure 405-b, and may therefore re-initiate the RACH procedure 405-b by transmitting a set of PRACH retransmissions 425-b. The PRACH transmissions 415-m, 415-n, 415-o, and 415-p may include examples of repetitions of Msg1 and/or Msg3, where the UE 115 increments a preamble transmission counter N (e.g., repetition counter) for each PRACH transmission 415, including the PRACH transmissions 415 included in the initial set of PRACH transmissions 410-b. For example, as shown in FIG. 4, the UE 115 may set the repetition counter N=5 for the PRACH transmission 415-m, N=6 for the PRACH transmission 415-n, N=7 for the PRACH transmission 415-o, and N=8 for the PRACH transmission 415-p.

In this example, the UE 115 may transmit the set of PRACH retransmissions 425-b using a second spatial filter 420-b that is different from the first spatial filter 420-a which was used to transmit the initial set of PRACH transmissions 410-a. In this regard, the UE 115 changes at least one spatial filter 420 used to perform the PRACH retransmissions 425-b. Accordingly, the UE 115 may suspend the power ramping counter (e.g., refrain from incrementing the power ramping counter, retain the same value of the power ramping counter) based on using at least one different spatial filter 420 for the PRACH retransmissions 425-b as were used for the set of initial PRACH transmissions 410-b. In this regard, the UE 115 may use a same transmission power to transmit the set of PRACH retransmissions 425-b as were used to transmit the initial set of PRACH transmissions 410-b based on retaining the same value of the power ramping counter.

RACH procedures 405-a and 405-b illustrate different techniques the UE 115 may use in an attempt to increase a probability that the respective RACH procedure 405 will be successful following re-initiation. In particular, in the context of the first RACH procedure 405-a, the UE 115 may increase a probability that the first RACH procedure 405-a will be successful by increasing the power ramping counter, and therefore increasing the transmission power of the set of PRACH retransmissions 425-b. Comparatively, in the context of the second RACH procedure 405-b, the UE 115 may increase a probability that the second RACH procedure 405-b will be successful by changing one or more spatial filters 420 used to transmit the set of PRACH retransmissions 425-b.

FIG. 5 illustrates an example of a resource configuration 500 that supports techniques for multiple PRACH transmissions in accordance with aspects of the present disclosure. Aspects of the resource configuration 500 may implement, or be implemented by, aspects of the wireless communications system 100, the wireless communications system 200, resource configuration 300, resource configuration 400, or any combination thereof.

The resource configuration 500 illustrates RACH procedures 505-a, 505-b in which a UE 115 identifies a failure of the respective RACH procedure 505, re-initiates the RACH procedure 505, and sets a value of a power ramping counter based on the spatial filters used to re-initiate the RACH procedure 505, as described previously herein. In particular, the first RACH procedure 505-a illustrates a case in which a UE 115 maintains the same spatial filter to re-initiate the RACH procedure 505-a, and therefore increments a power ramping counter. Comparatively, the second RACH procedure 505-b illustrates a case in which a UE 115 changes at least one spatial filter used to re-initiate the RACH procedure 505-b, and therefore refrains from incrementing the power ramping counter (e.g., retains the same value of the power ramping counter).

For example, referring to the first RACH procedure 505-a, a UE 115 may transmit an initial set of PRACH transmissions 510-a of the PRACH procedure 505-a. The PRACH transmissions 515-a, 515-b, 515-c, and 515-d may include examples of repetitions of Msg1 and/or Msg3, where the UE 115 increments a preamble transmission counter N (e.g., repetition counter) for each PRACH transmission 515. For example, as shown in FIG. 4, the UE 115 may set the repetition counter N=1 for the first PRACH transmission 515-a, N=2 for the second PRACH transmission 515-b, N=3 for the third PRACH transmission 515-c, and N=4 for the fourth PRACH transmission 515-d.

In some aspects, the UE 115 may transmit the initial set of PRACH transmissions 510-a (e.g., PRACH transmissions 515-a, 515-b, 515-c, 515-d) using a first spatial filter 520-a and a second spatial filter 520-b. For example, the UE 115 may transmit the PRACH transmissions 515-a and 515-b using the first spatial filter 520-a, and may transmit the PRACH transmission 515-c and 515-d using the second spatial filter 520-b. The first and second spatial filters 520-a, 520-b may be associated with reference signals (e.g., SSBs) received from a network node 105. For instance, the first spatial filter 520-a may correspond to SSB #0, where the second spatial filter 520-b may correspond to SSB #1. The UE 115 may set a power ramping counter to 1 for each of the PRACH transmissions 515-a through 515-d (e.g., PREAMBLE_POWER_RAMPING_COUNTER=1 for N=1, . . . 4).

Subsequently, the UE 115 may identify a failure of the RACH procedure 505-a, and may therefore re-initiate the RACH procedure 505-a by transmitting a set of PRACH retransmissions 525-a. The PRACH transmissions 515-e, 515-f, 515-g, and 515-h may include examples of repetitions of Msg1 and/or Msg3, where the UE 115 increments a preamble transmission counter N (e.g., repetition counter) for each PRACH transmission 515, including the PRACH transmissions 515 included in the initial set of PRACH transmissions 510-a. For example, as shown in FIG. 4, the UE 115 may set the repetition counter N=5 for the PRACH transmission 515-e, N=6 for the PRACH transmission 515-f, N=7 for the PRACH transmission 515-g, and N=8 for the PRACH transmission 515-h.

In this example, the UE 115 may transmit the set of PRACH retransmissions 525-a using the same spatial filters 520 (e.g., first spatial filter 520-a and second spatial filter 520-b) as were used to transmit the initial set of PRACH transmissions 510-a. In this regard, the spatial filters 520 for retransmission (e.g., used to re-initiate the RACH procedure 505-a) are completely the same as initial transmission. Accordingly, the UE 115 may increment the power ramping counter based on using the same spatial filters 520-a, 520-b for retransmission. In other words, the UE 115 may increment PREAMBLE_POWER_RAMPING_COUNTER by 1 (e.g., preamble ramping counter-2) for each PRACH transmission 515 of the set of PRACH retransmissions 525-a. In this regard, the UE 115 may increase a transmission power used to transmit the set of PRACH retransmissions 525-a relative to the transmission power used to transmit the initial PRACH transmissions 510-a based on incrementing the power ramping counter.

Reference will now be made to the second RACH procedure 505-b. As described previously, a UE 115 may transmit an initial set of PRACH transmissions 510-b of the PRACH procedure 505-b. The PRACH transmissions 515-i, 515-j, 515-k, and 515-l may include examples of repetitions of Msg1 and/or Msg3, where the UE 115 increments a preamble transmission counter N (e.g., repetition counter) for each PRACH transmission 515. For example, as shown in FIG. 5, the UE 115 may set the repetition counter N=1 for the first PRACH transmission 515-i, N=2 for the second PRACH transmission 515-j, N=3 for the third PRACH transmission 515-k, and N=4 for the fourth PRACH transmission 515-l.

In some aspects, the UE 115 may transmit the initial set of PRACH transmissions 510-b (e.g., PRACH transmissions 515-i, 515-j, 515-k, 515-l) using the first spatial filter 520-a and the second spatial filter 520-b. For example, the UE 115 may transmit the PRACH transmissions 515-i and 515-j using the first spatial filter 520-a, and may transmit the PRACH transmission 515-k and 515-l using the second spatial filter 520-b. The first spatial filters 520-a, 520-b may be associated with a reference signal (e.g., SSB) received from a network node 105. For instance, the first spatial filter 520-a may correspond to SSB #0, where the second spatial filter 520-b may correspond to SSB #1. The UE 115 may set a power ramping counter to 1 for each of the PRACH transmissions 515-i through 515-l (e.g., PREAMBLE_POWER_RAMPING_COUNTER=1 for N=1, . . . 4).

Subsequently, the UE 115 may identify a failure of the RACH procedure 505-b, and may therefore re-initiate the RACH procedure 505-b by transmitting a set of PRACH retransmissions 525-b. The PRACH transmissions 515-m, 515-n, 515-o, and 515-p may include examples of repetitions of Msg1 and/or Msg3, where the UE 115 increments a preamble transmission counter N (e.g., repetition counter) for each PRACH transmission 515, including the PRACH transmissions 515 included in the initial set of PRACH transmissions 510-b. For example, as shown in FIG. 5, the UE 115 may set the repetition counter N=5 for the PRACH transmission 515-m, N=6 for the PRACH transmission 515-n, N=7 for the PRACH transmission 515-o, and N=8 for the PRACH transmission 515-p.

In this example, the UE 115 may transmit the set of PRACH retransmissions 525-b using a third spatial filter 520-c and the second spatial filter 520-b. For example, the UE 115 may transmit the PRACH transmissions 515-m and 515-n using the third spatial filter 520-c, and may transmit the PRACH transmission 515-o and 515-p using the second spatial filter 520-b. In this example, the third spatial filter 520-c may correspond to SSB #2. In this regard, the UE 115 may utilize at least one different spatial filter 520 to transmit the set of PRACH retransmissions 525-b as were used to transmit the initial set of PRACH transmissions 510-b. Accordingly, the UE 115 may suspend the power ramping counter (e.g., refrain from incrementing the power ramping counter, retain the same value of the power ramping counter) based on using at least one different spatial filter 520 for the PRACH retransmissions 525-b as were used for the set of initial PRACH transmissions 510-b. In this regard, the UE 115 may use a same transmission power to transmit the set of PRACH retransmissions 525-b as were used to transmit the initial set of PRACH transmissions 510-b based on retaining the same value of the power ramping counter.

RACH procedures 505-a and 505-b illustrate different techniques the UE 115 may use in an attempt to increase a probability that the respective RACH procedure 505 will be successful following re-initiation. In particular, in the context of the first RACH procedure 505-a, the UE 115 may increase a probability that the first RACH procedure 505-a will be successful by increasing the power ramping counter, and therefore increasing the transmission power of the set of PRACH retransmissions 525-b. Comparatively, in the context of the second RACH procedure 505-b, the UE 115 may increase a probability that the second RACH procedure 505-b will be successful by changing one or more spatial filters 520 used to transmit the set of PRACH retransmissions 525-b.

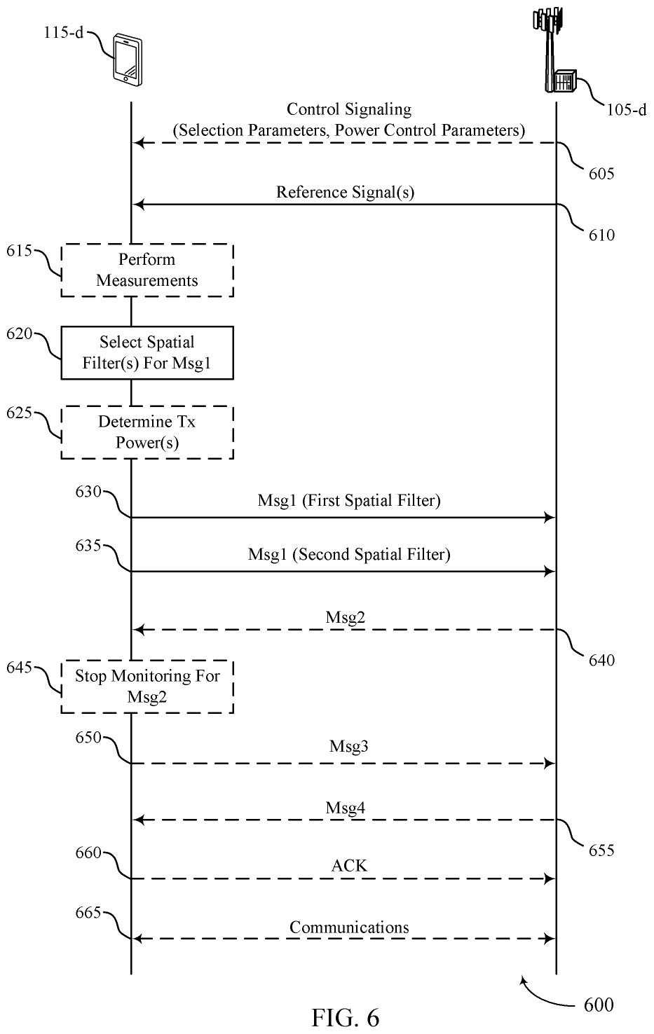

FIG. 6 illustrates an example of a process flow 600 that supports techniques for multiple PRACH transmissions in accordance with aspects of the present disclosure. In some examples, process flow 600 may implement, or be implemented by, aspects of wireless communications systems 100, wireless communications system 200, resource configurations 300-500, or any combination thereof. For example, the process flow 600 may illustrate a random access procedure between a UE 115-d and a network node 105-d (e.g., base station), where the UE 115-d transmits multiple repetitions of random access messages using multiple spatial filters, as described with reference to FIGS. 1-5.

In some cases, process flow 600 may include a UE 115-d and a network node 105-d, which may be examples of corresponding devices as described herein. For example, the UE 115-d and the network node 105-d illustrated in FIG. 6 may be examples of the UE 115-a and the network node 105-a (e.g., base station) illustrated in FIG. 2.

In some examples, the operations illustrated in process flow 600 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 605, the UE 115-d may receive control signaling from the network node 105-d (e.g., base station). The control signaling may include RRC signaling, SIB signaling, and the like. In some aspects, the control signaling may indicate parameters associated with spatial filters usable for wireless communications between the UE 115-d and the network node 105-d.

For example, in some cases, the control signaling may indicate one or more parameters associated with selection of spatial filters at the UE 115-d that will be used to transmit RACH messages, selection of spatial filters that will be used to determine transmission powers of RACH messages, or both. For instance, in some cases, the control signaling may configure the UE 115-b to select spatial filters that will be used to transmit Msg1 of a RACH procedure based on spatial filters exhibiting RSRP values that satisfy some RSRP threshold, spatial filters with the highest RSRP threshold, or both. In this regard, the control signaling may configure the UE 115-d to select the spatial filters with the highest RSRP as the spatial filters used to transmit the first random access message of a RACH procedure. Additionally, or alternatively, control signaling may configure the UE 115-d to utilize the spatial filter with the highest or lowest pathloss metric as the spatial filter that will be used to determine the transmission power for the first random access message of the RACH procedure.

By way of another example, in some cases, the control signaling may indicate sets of power control parameters associated with respective spatial filters usable for wireless communications between the UE 115-d and the network node 105-d. For instance, the control signaling may indicate a first set of power control parameters associated with a first spatial filter, and a second set of power control parameters associated with a second spatial filter. In this regard, the control signaling may configure sets of power control parameters usable by the UE 115-d to determine transmission powers of RACH messages transmitted via the respective spatial filters. Power control parameters associated with the respective spatial filters may include, but are not limited to, a preamble received target power parameter (e.g., preambleReceivedTargetPower), a maximum transmission parameter (e.g., preambleTransMax), a power ramping step parameter (e.g., powerRampingStep), and the like.

At 610, the UE 115-d may receive one or more reference signals (e.g., SSB messages, CSI-RSs) from the network node 105-d. The one or more reference signals may be associated with one or more spatial filters. For example, the network node 105-d may transmit a first reference signal using a first spatial filter, and a second reference signal using a second spatial filter. In some cases, the UE 115-d may receive the one or more reference signals at 610 based on receiving the control signaling at 605.

At 615, the UE 115-d may perform measurements on the reference signals received at 610. In particular, the UE 115-d may be configured to perform measurements on the received reference signals in order to determine what spatial filter(s) will be used to perform communications associated with a random access procedure (e.g., RACH procedure) with the network node 105-d. In this regard, the UE 115-a may be configured to perform measurements on the received reference signals in order to determine characteristics (e.g., performance) of the respective spatial filters. As such, the UE 115-d may perform the measurements at 615 based on receiving the control signaling at 605, receiving the reference signals at 610, or both.

Measurements performed on the received reference signals (e.g., characteristics of the respective spatial filters) may include RSRP measurements, RSRQ measurements, SNR measurements, SINR measurements, CQI measurements, pathloss measurements, or any combination thereof. For example, the UE 115-d may determine a first RSRP measurement and a first pathloss metric associated with a first reference signal transmitted via the first spatial filter, and may determine a second RSRP measurement and a second pathloss metric associated with a second reference signal transmitted via the second spatial filter.

At 620, the UE 115-d may select one or more spatial filters that will be used to transmit a first random access message (e.g., Msg1) of a random access procedure performed between the UE 115-d and the network node 105-d. The UE 115-d may select the one or more spatial filters based on receiving the control signaling at 605, receiving the reference signals at 610, performing the measurements at 615, or any combination thereof.

For example, the UE 115-d may determine characteristics/performance associated with each respective spatial filter based on the measurements at 615, and may select one or more spatial filters based on the comparison. For instance, the UE 115-d may select the spatial filters with the highest RSRP values, the spatial filters with RSRP values which satisfy some RSRP threshold, or both. Moreover, in cases where the control signaling at 605 indicates parameters associated with a selection of spatial filters, the UE 115-d may select the spatial filters at 620 in accordance with the parameters. For instance, the control signaling may configure the UE 115-d to select the spatial filters with the highest RSRP values, the lowest pathloss metrics, or both.

At 625, the UE 115-d may determine one or more transmission powers that will be used to transmit one or more repetitions of a first random access message of a random access procedure (e.g., transmission powers for repetitions of Msg1). The UE 115-d may determine the one or more transmission powers based on receiving the control signaling at 605, receiving the reference signals at 610, performing the measurements at 615, selecting the spatial filters used for the repetition(s) of Msg1 at 620, or any combination thereof.

As described previously herein, there are multiple different implementations for determining transmission power(s) used to transmit repetitions of random access messages. In accordance with a first implementation, the UE 115-d may determine a single transmission power that will be used to transmit each repetition of the random access message.

For example, in accordance with a first implementation, the UE 115-d may determine a single transmission power that will be used to transmit each repetition of Msg1, where the single transmission power is determined based on one of the spatial filters that will be used to transmit the repetitions of Msg1. For instance, in cases where the UE 115-d selects the first and second spatial filters at 620, the UE 115-d may determine a single transmission power based on one of the first spatial filter or the second spatial filter. In such cases, the UE 115-d may determine which spatial filter that will be used to determine the transmission power based on characteristics of the spatial filters (e.g., RSRP, pathloss metrics, etc.), parameters associated with selection of spatial filters configured via the control signaling at 605, or any combination thereof. For example, the UE 115-d may be configured to determine the transmission power based on the first or second spatial filter with the highest or lowest RSRP, highest or lowest pathloss metric, and the like.

In accordance with a second implementation, the UE 115-d may determine different transmission powers for each respective repetition of Msg1 based on the corresponding spatial filters that will be used to transmit the respective Msg1 repetitions. In particular, the UE 115-d may be configured to determine pathloss metrics for each respective spatial filter based on the sets of power control parameters corresponding to the respective spatial filters. For example, the UE 115-d may determine a first transmission power associated with the first spatial filter based on the first set of power control parameters corresponding to the first spatial filer, and may determine a second transmission power associated with the second spatial filter based on the second set of power control parameters corresponding to the second spatial filer. In this example, the first and second transmission powers may be further determined based on measurements for the first and second spatial filters performed at 615. That is, the first transmission power may be determined based on characteristics (e.g., RSRP, pathloss metrics) associated with the first spatial filter and the first set of power control parameters, and the second transmission power may be determined based on characteristics (e.g., RSRP, pathloss metrics) associated with the second spatial filter and the second set of power control parameters.

At 630, the UE 115-d may transmit, to the network node 105-d, a first repetition of a first random access message (e.g., Msg1) of a random access procedure. The random access procedure may include a two-step random access procedure, a four-step random access procedure, or both. For the purposes of simplicity, the process flow 600 is shown and described in the context of a four-step random access procedure. However, this is not to be regarded as a limitation of the present disclosure, and aspects of process flow 600 may additionally or alternatively be implemented in the context of a two-step random access procedure.

The UE 115-d may transmit the first repetition of Msg1 based on receiving the control signaling at 605, receiving the reference signals at 610, performing the measurements at 615, selecting the spatial filter(s) at 620, determining the transmission power(s) at 625, or any combination thereof. For example, the UE 115-d may transmit the first repetition of Msg1 via the first spatial filter that was selected at 620. By way of another example, in cases where the UE 115-d determines a single transmission power at 630 that will be used for each repetition of Msg1, the UE 115-d may transmit the first repetition of Msg1 at 630 in accordance with (e.g., using) the single transmission power. Comparatively, in cases where the UE 115-d determines a first transmission power associated with the first spatial filter and a second transmission power associated with the second spatial filter, the UE 115-d may transmit the first repetition of Msg1 using the first transmission power.

At 635, the UE 115-d may transmit, to the network node 105-d, a second repetition of the first random access message (e.g., Msg1) of the random access procedure. The UE 115-d may transmit the second repetition of Msg1 based on receiving the control signaling at 605, receiving the reference signals at 610, performing the measurements at 615, selecting the spatial filter(s) at 620, determining the transmission power(s) at 625, transmitting the first repetition of Msg1 at 630, or any combination thereof.

For example, the UE 115-d may transmit the second repetition of Msg1 via the second spatial filter that was selected at 620. By way of another example, in cases where the UE 115-d determines a single transmission power at 630 that will be used for each repetition of Msg1, the UE 115-d may transmit the second repetition of Msg1 at 635 in accordance with (e.g., using) the single transmission power. In such cases, the UE 115-d may transmit the first and second repetitions of Msg1 at 630 and 635, respectively, using different spatial filters but the same transmission power. Comparatively, in cases where the UE 115-d determines a first transmission power associated with the first spatial filter and a second transmission power associated with the second spatial filter, the UE 115-d may transmit the second repetition of Msg1 using the second transmission power.

At 640, the UE 115-d may receive, from the network node 105-d, a second random access message (e.g., Msg2) of the random access procedure. The UE 115-d may receive the second random access message at 640 based on (e.g., in response to) transmitting the first repetition of the first random access message at 630, transmitting the second repetition of the first random access message at 635, or both.

Moreover, in some implementations, the network node 105-d may transmit Msg2 using one of the spatial filters that was used to transmit/receive the repetitions of Msg1 at 630 and 635. For example, in cases where the UE 115-d transmits the first and second repetitions of Msg1 using the first and second spatial filters, respectively, the network node 105-d may transmit Msg2 at 640 using one of the first or second spatial filters. In this regard, the UE 115-d may monitor for RACH messages transmitted using the first and second spatial filters upon transmitting the repetitions of Msg1 using the first and second spatial filters.

At 645, the UE 115-d may stop monitoring for additional repetitions of the second random access message (e.g., stop monitoring for repetitions of Msg2). In particular, the UE 115-d may stop monitoring for repetitions of Msg2 based on successfully receiving and/or decoding the repetition of Msg2 at 640. In other words, the UE 115-d may stop monitoring and/or decoding repetitions of Msg2 once the UE 115-d successfully receives and decodes a Msg2. In this regard, even in cases where the network node 105-d transmits additional repetitions of Msg2, the UE 115-d may not successfully receive and/or decode the additional repetitions of Msg2.

As noted previously herein, the UE 115-d may be configured to utilize the spatial filter associated with the first-received repetition of Msg2 to transmit/receive subsequent random access messages of the random access procedure. That is, the spatial filter associated with the first repetition of Msg2 that is successfully received/decoded by the UE 115-d will be used to perform remaining RACH messages of the random access procedure. For example, in cases where Msg2 at 640 is transmitted/received using the first spatial filter, the UE 115-d may be configured to transmit Msg3 and receive Msg4 using the first spatial filter. Comparatively, in cases where Msg2 at 640 is transmitted/received using the second spatial filter, the UE 115-d may be configured to transmit Msg3 and receive Msg4 using the second spatial filter.

At 650, the UE 115-d may transmit a third random access message (e.g., Msg3) of the random access procedure to the network node 105-d. The UE 115-d may transmit Msg3 at 650 based on transmitting the first repetition of Msg1 at 630, transmitting the second repetition of Msg1 at 635, receiving Msg2 at 640, refraining from monitoring for additional repetitions of Msg2 at 645, or any combination thereof. For example, the UE 115-d may transmit Msg3 using the same spatial filter as was used to transmit/receive Msg2 at 640. For instance, in cases where Msg2 at 640 is transmitted/received using the first spatial filter, the UE 115-d may be configured to transmit Msg3 using the first spatial filter. Comparatively, in cases where Msg2 at 640 is transmitted/received using the second spatial filter, the UE 115-d may be configured to transmit Msg3 using the second spatial filter.

At 655, the UE 115-d may receive a fourth random access message (e.g., Msg4) of the random access procedure from the network node 105-d. The UE 115-d may receive Msg4 at 655 based on transmitting the first repetition of Msg1 at 630, transmitting the second repetition of Msg1 at 635, receiving Msg2 at 640, refraining from monitoring for additional repetitions of Msg2 at 645, transmitting Msg3 at 650, or any combination thereof. For example, the UE 115-d may receive Msg4 using the same spatial filter as was used to transmit/receive Msg2 at 640 and transmit/receive Msg3 at 650. For instance, in cases where Msg2 at 640 is transmitted/received using the first spatial filter, the UE 115-d may be configured to receive Msg4 using the first spatial filter. Comparatively, in cases where Msg2 at 640 is transmitted/received using the second spatial filter, the UE 115-d may be configured to receive Msg4 using the second spatial filter.

At 660, the UE 115-d may transmit a feedback message (e.g., ACK message) to the base station 105-d. The UE 115-d may transmit the ACK message at 660 based on receiving Msg4 at 655, and therefore completing the random access procedure with the base station 105-d.

At 665, the UE 115-d may communicate with the network node 105-d. In particular, the UE 115-d and the network node 105-d may communicate at 665 based on the completion of the random access procedure. In this regard, the UE 115-d and the network node 105-d may communicate with one another at 665 based on transmitting/receiving Msg4 at 655, transmitting/receiving the ACK message at 660, or both.

Techniques described herein may enable UEs 115 and base stations 105 to more efficiently and reliably determine what transmit powers will be used to transmit repetitions of RACH messages associated with RACH procedures performed between the UEs 115 and the network. In this regard, techniques described herein may enable the network (e.g., base stations 105) to expect certain transmission powers of the RACH procedure, combine repetitions of RACH messages, and efficiently decode RACH messages. Moreover, aspects described herein may improve the ability of the network and UEs 115 to perform RACH procedures using multiple spatial filters, which increases redundancy of RACH messages and improves the probability that the RACH procedure will be successful. Further, aspects described herein may enable wireless devices to more efficiently and reliably determine which spatial filter(s) will be used to perform RACH procedures, further improving the reliability of RACH procedures, reducing latency at UEs 115, and improving overall user experience, among other benefits.

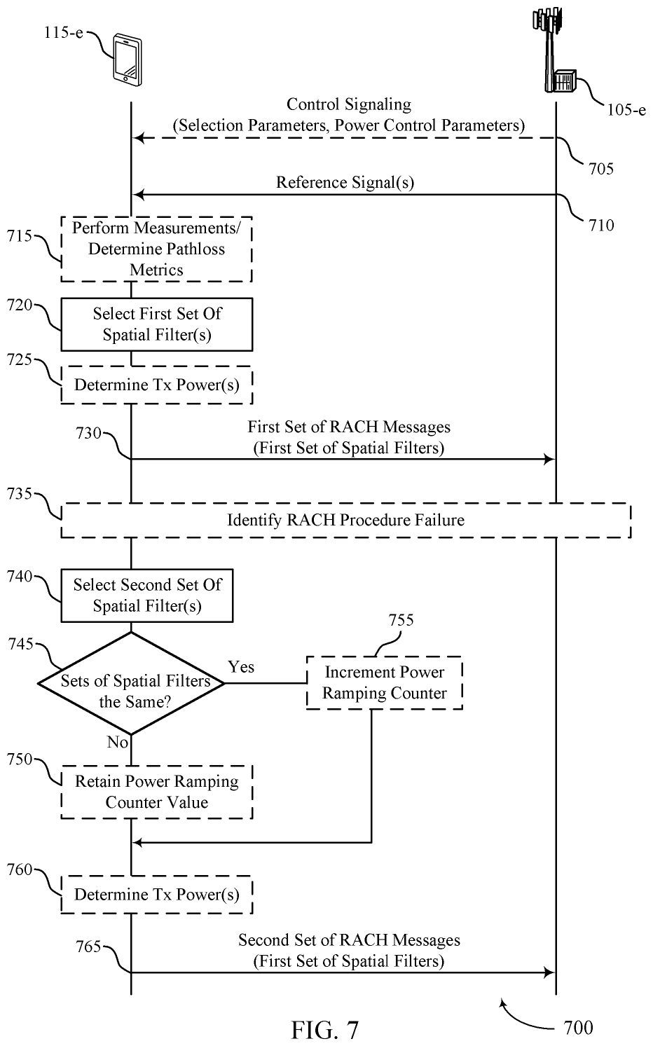

FIG. 7 illustrates an example of a process flow 700 that supports techniques for multiple PRACH transmissions in accordance with aspects of the present disclosure. In some examples, process flow 700 may implement, or be implemented by, aspects of wireless communications systems 100, wireless communications system 200, resource configurations 300-500, process flow 600, or any combination thereof. For example, the process flow 700 may illustrate a random access procedure between a UE 115-e and a network node 105-e (e.g., base station), where the UE 115-e identifies a failure of the random access procedure, re-initiates the random access procedure, and increments (or refrains from increments) a power ramping counter based on the spatial filters used to re-initiate the random access procedure, as described with reference to FIGS. 1-5.

In some cases, process flow 700 may include a UE 115-e and a network node 105-e, which may be examples of corresponding devices as described herein. For example, the UE 115-e and the network node 105-e illustrated in FIG. 7 may be examples of the UE 115-a and the network node 105-a (e.g., base station) illustrated in FIG. 2.

In some examples, the operations illustrated in process flow 700 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 705, the UE 115-e may receive control signaling from the network node 105-e (e.g., base station). The control signaling may include RRC signaling, SIB signaling, and the like. In some aspects, the control signaling may indicate parameters associated with spatial filters usable for wireless communications between the UE 115-e and the network node 105-e.

For example, in some cases, the control signaling may indicate one or more parameters associated with selection of spatial filters at the UE 115-e that will be used to transmit RACH messages, selection of spatial filters that will be used to determine transmission powers of RACH messages, or both. For instance, in some cases, the control signaling may configure the UE 115-b to select spatial filters that will be used to transmit Msg1 of a RACH procedure based on spatial filters exhibiting RSRP values that satisfy some RSRP threshold, spatial filters with the highest RSRP threshold, or both. In this regard, the control signaling may configure the UE 115-e to select the spatial filters with the highest RSRP as the spatial filters used to transmit the first random access message of a RACH procedure. Additionally, or alternatively, control signaling may configure the UE 115-e to utilize the spatial filter with the highest or lowest pathloss metric as the spatial filter that will be used to determine the transmission power for the first random access message of the RACH procedure.

By way of another example, in some cases, the control signaling may indicate sets of power control parameters associated with respective spatial filters usable for wireless communications between the UE 115-e and the network node 105-e. For instance, the control signaling may indicate a first set of power control parameters associated with a first spatial filter, and a second set of power control parameters associated with a second spatial filter. In this regard, the control signaling may configure sets of power control parameters usable by the UE 115-e to determine transmission powers of RACH messages transmitted via the respective spatial filters. Power control parameters associated with the respective spatial filters may include, but are not limited to, a preamble received target power parameter (e.g., preambleReceivedTargetPower), a maximum transmission parameter (e.g., preambleTransMax), a power ramping step parameter (e.g., powerRampingStep), and the like.

At 710, the UE 115-e may receive one or more reference signals (e.g., SSB messages, CSI-RSs) from the network node 105-e. The one or more reference signals may be associated with one or more spatial filters. For example, the network node 105-e may transmit a first reference signal using a first spatial filter, and a second reference signal using a second spatial filter. In some cases, the UE 115-e may receive the one or more reference signals at 710 based on receiving the control signaling at 705.

At 715, the UE 115-e may perform measurements on the reference signals received at 710. In particular, the UE 115-e may be configured to perform measurements on the received reference signals in order to determine what spatial filter(s) will be used to perform communications associated with a random access procedure (e.g., RACH procedure) with the network node 105-e. In this regard, the UE 115-a may be configured to perform measurements on the received reference signals in order to determine characteristics (e.g., performance) of the respective spatial filters. As such, the UE 115-e may perform the measurements at 715 based on receiving the control signaling at 705, receiving the reference signals at 710, or both.

Measurements performed on the received reference signals (e.g., characteristics of the respective spatial filters) may include RSRP measurements, RSRQ measurements, SNR measurements, SINR measurements, CQI measurements, pathloss measurements, or any combination thereof. For example, the UE 115-e may determine a first RSRP measurement and a first pathloss metric associated with a first reference signal transmitted via the first spatial filter, and may determine a second RSRP measurement and a second pathloss metric associated with a second reference signal transmitted via the second spatial filter.

At 720, the UE 115-e may select a first set of one or more spatial filters that will be used to transmit a first random access message (e.g., Msg1) of a random access procedure performed between the UE 115-e and the network node 105-e. The UE 115-e may select the first set of spatial filters based on receiving the control signaling at 705, receiving the reference signals at 710, performing the measurements at 715, or any combination thereof.

For example, the UE 115-e may determine characteristics/performance associated with each respective spatial filter based on the measurements at 715, and may select the first set of spatial filters based on the comparison. For instance, the UE 115-e may select the spatial filters with the highest RSRP values, the spatial filters with RSRP values which satisfy some RSRP threshold, or both. Moreover, in cases where the control signaling at 705 indicates parameters associated with a selection of spatial filters, the UE 115-e may select the first set of spatial filters at 720 in accordance with the parameters. For instance, the control signaling may configure the UE 115-e to select the spatial filters with the highest RSRP values, the lowest pathloss metrics, or both.

At 725, the UE 115-e may determine one or more transmission powers that will be used to transmit one or more repetitions of a first random access message of a random access procedure (e.g., transmission power(s) for repetitions of Msg1). The UE 115-e may determine the one or more transmission powers based on receiving the control signaling at 705, receiving the reference signals at 710, performing the measurements at 715, selecting the first set of spatial filters at 720, or any combination thereof.

As described previously herein, there are multiple different implementations for determining transmission power(s) used to transmit repetitions of random access messages. In accordance with a first implementation, the UE 115-e may determine a single transmission power that will be used to transmit each repetition of the random access message.

For example, in accordance with a first implementation, the UE 115-e may determine a single transmission power that will be used to transmit each repetition of Msg1, where the single transmission power is determined based on one of the spatial filters that will be used to transmit the repetitions of Msg1. For instance, in cases where the UE 115-e selects the first and second spatial filters at 720, the UE 115-e may determine a single transmission power based on one of the first spatial filter or the second spatial filter. In such cases, the UE 115-e may determine which spatial filter that will be used to determine the transmission power based on characteristics of the spatial filters (e.g., RSRP, pathloss metrics, etc.), parameters associated with selection of spatial filters configured via the control signaling at 705, or any combination thereof. For example, the UE 115-e may be configured to determine the transmission power based on the first or second spatial filter with the highest or lowest RSRP, highest or lowest pathloss metric, and the like.

In accordance with a second implementation, the UE 115-e may determine different transmission powers for each respective repetition of Msg1 based on the corresponding spatial filters that will be used to transmit the respective Msg1 repetitions. In particular, the UE 115-e may be configured to determine pathloss metrics for each respective spatial filter based on the sets of power control parameters corresponding to the respective spatial filters. For example, the UE 115-e may determine a first transmission power associated with the first spatial filter based on the first set of power control parameters corresponding to the first spatial filer, and may determine a second transmission power associated with the second spatial filter based on the second set of power control parameters corresponding to the second spatial filer. In this example, the first and second transmission powers may be further determined based on measurements for the first and second spatial filters performed at 715. That is, the first transmission power may be determined based on characteristics (e.g., RSRP, pathloss metrics) associated with the first spatial filter and the first set of power control parameters, and the second transmission power may be determined based on characteristics (e.g., RSRP, pathloss metrics) associated with the second spatial filter and the second set of power control parameters.

At 730, the UE 115-e may transmit, to the network node 105-e, a first set of RACH messages (e.g., one or more repetitions of Msg1, one or more repetitions of Msg3) of a random access procedure. The random access procedure may include a two-step random access procedure, a four-step random access procedure, or both. The UE 115-e may transmit the first set of RACH messages based on receiving the control signaling at 705, receiving the reference signals at 710, performing the measurements at 715, selecting the first set of spatial filters at 720, determining the transmission power(s) at 725, or any combination thereof.

For example, the UE 115-e may transmit the first set RACH messages via the first spatial filter that was selected at 720, as shown and described with reference to FIG. 4. Moreover, in cases where the UE 115-e selects the first spatial filter and the second spatial filter at 720, the UE 115-e may transmit the first set of RACH messages via the first and second spatial filters, as shown and described with reference to FIG. 5.

As noted previously herein, the transmission power for the first set of RACH messages may be determined in accordance with a power ramping counter, where the power ramping counter is set to the same value for each RACH message of the first set of RACH messages. In particular, the UE 115-e may set a power ramping counter to 1 for each of the RACH messages of the first set of RACH messages. That is, in cases where the first set of RACH messages include multiple repetitions of Msg1 or Msg3, the UE 115-e may set PREAMBLE_POWER_RAMPING_COUNTER=1 for each repetition of Msg1 or Msg3 at 730.

At 735, the UE 115-d, the network node 105-e, or both, may identify a failure of the random access procedure. The random access procedure may fail when the UE 115-e does not receive Msg2 and/or Msg4 within some time interval (e.g., within a RAR window), when a contention resolution timer (e.g., ra-ContentionResolutionTimer) expires, when a contention resolution fails, or any combination thereof.

For example, in cases where the first set of RACH messages at 730 include repetitions of Msg1, the UE 115-e may be configured to identify a failure of the random access procedure based on identifying an absence of Msg2 within a RAR window. Similarly, in cases where the first set of RACH messages at 730 include repetitions of Msg3, the UE 115-e may be configured to identify a failure of the random access procedure based on identifying an absence of Msg4 within a RAR window.

Upon identifying a failure of the random access procedure, the UE 115-e may be configured to re-initiate the random access procedure (e.g., start a new RACH procedure) by retransmitting one or more repetitions of a RACH message. In particular, the UE 115-e may be configured to reinitiate the random access procedure by transmitting one or more repetitions of Msg1. This may be further shown and described with reference to step 740 of process flow 700.

At 740, the UE 115-e may select a second set of spatial filters that will be used to transmit a random access message (e.g., Msg1, Msg3) of a random access procedure performed between the UE 115-e and the network node 105-e. In other words, the UE 115-e may select a set of spatial filters that will be used to re-initiate the random access procedure, start a new random access procedure, or both. The UE 115-e may select the second set of spatial filters based on receiving the control signaling at 705, receiving the reference signals at 710, performing the measurements at 715, selecting the first set of spatial filters at 720, transmitting the first set of random access messages at 730, identifying the failure of the random access procedure, or any combination thereof.

At 745, the UE 115-e may determine whether the first and second sets of spatial filters are the same. In particular, the UE 115-e may determine whether the second set of spatial filters includes at least one spatial filter that was not included within the first set of spatial filters.

If the second set of spatial filters includes at least one spatial filter that was not included within the first set of spatial filters such that the first and second sets are not the same (e.g., step 745=NO), the process flow 700 may proceed to step 750.

At 750, the UE 115-e may set the power ramping counter by retaining the same value of the power ramping counter. In particular, the UE 115-e may retain the same value of the power ramping counter based on identifying that the second set of spatial filters includes at least one spatial filter that was not included within the first set of spatial filters at 750 (e.g., based on selecting at least one different spatial filter to reinitiate the random access procedure). For example, as described in the second RACH procedure 405-b illustrated in FIG. 4 and the second RACH procedure 505-b illustrated in FIG. 5, the UE 115-e may retain the value of the power ramping counter (e.g., retain PREAMBLE_POWER_RAMPING_COUNTER=1) based on using at least one new spatial filter to reinitiate the random access procedure.

Reference will again be made to step 745. At 745, if the second set of spatial filters is the same as the first set of spatial filters (e.g., step 745=YES), the process flow 700 may proceed to step 755.

At 755, the UE 115-e may set the power ramping counter by incrementing the value of the power ramping counter. In particular, the UE 115-e may increment the power ramping counter based on identifying that the second set of spatial filters is the same as the first set of spatial filters at 750 (e.g., based on selecting the same spatial filter(s) to reinitiate the random access procedure). For example, as described in the first RACH procedure 405-a illustrated in FIG. 4 and the first RACH procedure 505-a illustrated in FIG. 5, the UE 115-e may increment the power ramping counter (e.g., set PREAMBLE_POWER_RAMPING_COUNTER=2) based on using the same spatial filter(s) to reinitiate the random access procedure.

At 760, the UE 115-e may determine one or more transmission powers that will be used to transmit one or more repetitions of a random access message of the reinitiated random access procedure (e.g., transmission power(s) for repetitions of Msg1). The UE 115-e may determine the one or more transmission powers based on selecting the second set of spatial filters at 740, determining whether the sets of spatial filters are the same at 745, retaining the value of the power ramping counter at 750, incrementing the power ramping counter at 755, or any combination thereof.

In particular, the UE 115-e may determine the one or more transmission powers at 760 based on the value of the power ramping counter. For example, in cases where the UE 115-e retains the same power ramping counter value at 750, the UE 115-e may determine one or more transmission powers which are the same as the transmission powers used to transmit the first set of random access messages at 730. Comparatively, in cases where the UE 115-e increments same power ramping counter value at 755, the UE 115-e may determine one or more new transmission powers which are different from (e.g., greater than) the transmission powers used to transmit the first set of random access messages at 730.

As described with reference to step 725, there are multiple different implementations for determining transmission power(s) used to transmit repetitions of random access messages. In accordance with a first implementation, the UE 115-e may determine a single transmission power that will be used to transmit each repetition of the random access message. Comparatively, in accordance with a second implementation, the UE 115-e may determine separate transmission powers for each respective spatial filter based on power control parameters associated with each respective spatial filter. As such, any description associated with the determination of the transmission powers at 725 may be regarded as applying to the determination of transmission powers at 760.

At 765, the UE 115-e may transmit, to the network node 105-e, a second set of RACH messages (e.g., one or more repetitions of Msg1, one or more repetitions of Msg3) of the random access procedure (e.g., two-step random access procedure, four-step random access procedure). The UE 115-e may transmit the second set of RACH messages based on selecting the second set of spatial filters at 740, determining whether the sets of spatial filters are the same at 745, retaining the value of the power ramping counter at 750, incrementing the power ramping counter at 755, determining the transmission power(s) at 760, or any combination thereof.

For example, the UE 115-e may transmit the second set of RACH messages using the second set of spatial filters selected at 740. By way of another example, the UE 115-e may transmit the second set of RACH messages using the one or more transmission powers determined at 760, where the transmission powers are based on the value of the power ramping counter that was set (e.g., incremented, retained) at 750 and 755.

Techniques described herein may enable UEs 115 and base stations 105 to more efficiently and reliably determine what transmit powers will be used to transmit repetitions of RACH messages associated with RACH procedures performed between the UEs 115 and the network. In this regard, techniques described herein may enable the network (e.g., base stations 105) to expect certain transmission powers of the RACH procedure, combine repetitions of RACH messages, and efficiently decode RACH messages. Moreover, aspects described herein may improve the ability of the network and UEs 115 to perform RACH procedures using multiple spatial filters, which increases redundancy of RACH messages and improves the probability that the RACH procedure will be successful. Further, aspects described herein may enable wireless devices to more efficiently and reliably determine which spatial filter(s) will be used to perform RACH procedures, further improving the reliability of RACH procedures, reducing latency at UEs 115, and improving overall user experience, among other benefits.

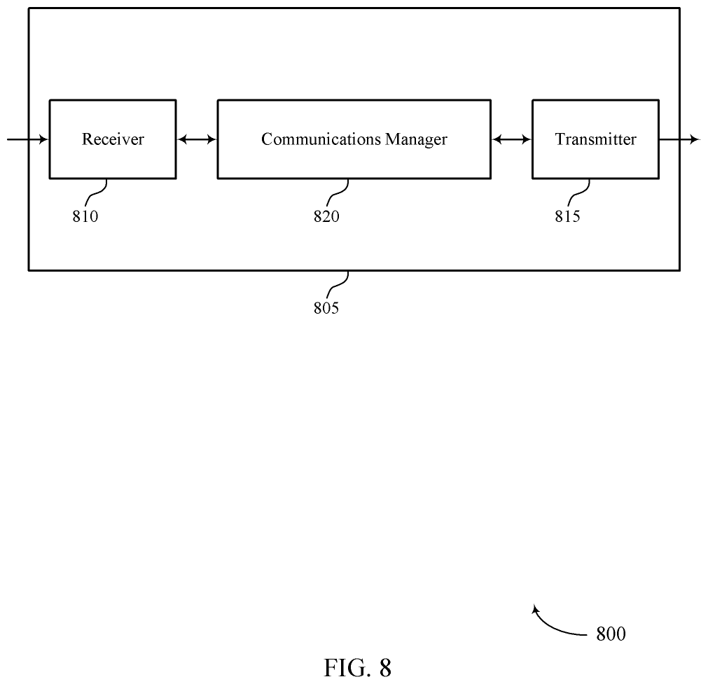

FIG. 8 shows a block diagram 800 of a device 805 that supports techniques for multiple PRACH transmissions in accordance with aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for multiple PRACH transmissions). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for multiple PRACH transmissions). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for multiple PRACH transmissions as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a UE in accordance with examples as disclosed herein. For example, the communications manager 820 may be configured as or otherwise support a means for receiving a set of multiple reference signals associated with a set of multiple spatial filters. The communications manager 820 may be configured as or otherwise support a means for transmitting, using a transmission power based on a single spatial filter of the set of multiple spatial filters, a first random access message of a random access procedure with a first spatial filter of the set of multiple spatial filters. The communications manager 820 may be configured as or otherwise support a means for transmitting, using the transmission power based on the single spatial filter of the set of multiple spatial filters, a second random access message of the random access procedure with a second spatial filter of the set of multiple spatial filters.

Additionally or alternatively, the communications manager 820 may support wireless communication at a UE in accordance with examples as disclosed herein. For example, the communications manager 820 may be configured as or otherwise support a means for receiving control signaling indicating a set of multiple sets of power control parameters associated with a set of multiple spatial filters. The communications manager 820 may be configured as or otherwise support a means for transmitting, using a first transmission power and in accordance with a first spatial filter of the set of multiple spatial filters, a first random access message of a random access procedure, where the first transmission power is based on a first set of power control parameters associated with the first spatial filter indicated via the control signaling, the first set of power control parameters included within the set of multiple sets of power control parameters. The communications manager 820 may be configured as or otherwise support a means for transmitting, using a second transmission power and in accordance with a second spatial filter of the set of multiple spatial filters, a second random access message of the random access procedure, where the second transmission power is based on a second set of power control parameters associated with the second spatial filter indicated via the control signaling, the second set of power control parameters included within the set of multiple sets of power control parameters.

Additionally or alternatively, the communications manager 820 may support wireless communication at a UE in accordance with examples as disclosed herein. For example, the communications manager 820 may be configured as or otherwise support a means for receiving a set of multiple reference signals associated with a set of multiple spatial filters. The communications manager 820 may be configured as or otherwise support a means for transmitting, based on receiving the set of multiple reference signals, a first random access message and a second random access message of a random access procedure, the first and second random access messages transmitted in accordance with a first spatial filter and a second spatial filter from the set of multiple spatial filters, respectively. The communications manager 820 may be configured as or otherwise support a means for receiving, based on the first random access message, the second random access message, or both, a third random access message of the random access procedure, where the third random access message is associated with one of the first spatial filter or the second spatial filter. The communications manager 820 may be configured as or otherwise support a means for transmitting, based on the third random access message, a fourth random access message of the random access procedure, where the fourth random access message is transmitted in accordance with the first spatial filter or the second spatial filter that is associated with the third random access message.

Additionally or alternatively, the communications manager 820 may support wireless communication at a UE in accordance with examples as disclosed herein. For example, the communications manager 820 may be configured as or otherwise support a means for transmitting a first set of random access messages of a random access procedure in accordance with a first set of one or more spatial filters, where the first set of random access messages are associated with a first value of a power ramping counter. The communications manager 820 may be configured as or otherwise support a means for selecting a second set of one or more spatial filters based on identifying a failure of the random access procedure. The communications manager 820 may be configured as or otherwise support a means for setting the power ramping counter to a value based on a comparison of the first set of one or more spatial filters and the second set of one or more spatial filters. The communications manager 820 may be configured as or otherwise support a means for transmitting a second set of random access messages associated with a second random access procedure in accordance with the second set of one or more spatial filters and using a transmission power that is based on the value of the power ramping counter.

By including or configuring the communications manager 820 in accordance with examples as described herein, the device 805 (e.g., a processor controlling or otherwise coupled to the receiver 810, the transmitter 815, the communications manager 820, or a combination thereof) may support techniques which enable UEs 115 and base stations 105 to more efficiently and reliably determine what transmit powers will be used to transmit repetitions of RACH messages associated with RACH procedures performed between the UEs 115 and the network. In this regard, techniques described herein may enable the network (e.g., base stations 105) to expect certain transmission powers of the RACH procedure, combine repetitions of RACH messages, and efficiently decode RACH messages. Moreover, aspects described herein may improve the ability of the network and UEs 115 to perform RACH procedures using multiple spatial filters, which increases redundancy of RACH messages and improves the probability that the RACH procedure will be successful. Further, aspects described herein may enable wireless devices to more efficiently and reliably determine which spatial filter(s) will be used to perform RACH procedures, further improving the reliability of RACH procedures, reducing latency at UEs 115, and improving overall user experience, among other benefits.

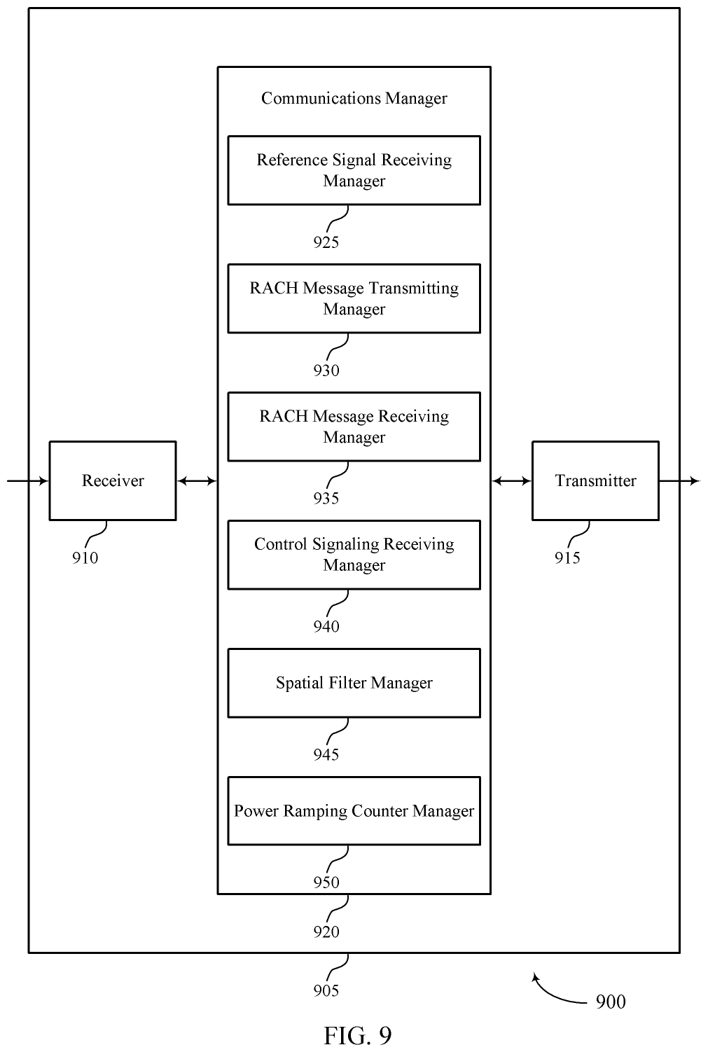

FIG. 9 shows a block diagram 900 of a device 905 that supports techniques for multiple PRACH transmissions in accordance with aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for multiple PRACH transmissions). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for multiple PRACH transmissions). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for multiple PRACH transmissions as described herein. For example, the communications manager 920 may include a reference signal receiving manager 925, a RACH message transmitting manager 930, a RACH message receiving manager 935, a control signaling receiving manager 940, a spatial filter manager 945, a power ramping counter manager 950, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a UE in accordance with examples as disclosed herein. The reference signal receiving manager 925 may be configured as or otherwise support a means for receiving a set of multiple reference signals associated with a set of multiple spatial filters. The RACH message transmitting manager 930 may be configured as or otherwise support a means for transmitting, using a transmission power based on a single spatial filter of the set of multiple spatial filters, a first random access message of a random access procedure with a first spatial filter of the set of multiple spatial filters. The RACH message receiving manager 935 may be configured as or otherwise support a means for transmitting, using the transmission power based on the single spatial filter of the set of multiple spatial filters, a second random access message of the random access procedure with a second spatial filter of the set of multiple spatial filters.

Additionally or alternatively, the communications manager 920 may support wireless communication at a UE in accordance with examples as disclosed herein. The control signaling receiving manager 940 may be configured as or otherwise support a means for receiving control signaling indicating a set of multiple sets of power control parameters associated with a set of multiple spatial filters. The RACH message transmitting manager 930 may be configured as or otherwise support a means for transmitting, using a first transmission power and in accordance with a first spatial filter of the set of multiple spatial filters, a first random access message of a random access procedure, where the first transmission power is based on a first set of power control parameters associated with the first spatial filter indicated via the control signaling, the first set of power control parameters included within the set of multiple sets of power control parameters. The RACH message transmitting manager 930 may be configured as or otherwise support a means for transmitting, using a second transmission power and in accordance with a second spatial filter of the set of multiple spatial filters, a second random access message of the random access procedure, where the second transmission power is based on a second set of power control parameters associated with the second spatial filter indicated via the control signaling, the second set of power control parameters included within the set of multiple sets of power control parameters.

Additionally or alternatively, the communications manager 920 may support wireless communication at a UE in accordance with examples as disclosed herein. The reference signal receiving manager 925 may be configured as or otherwise support a means for receiving a set of multiple reference signals associated with a set of multiple spatial filters. The RACH message transmitting manager 930 may be configured as or otherwise support a means for transmitting, based on receiving the set of multiple reference signals, a first random access message and a second random access message of a random access procedure, the first and second random access messages transmitted in accordance with a first spatial filter and a second spatial filter from the set of multiple spatial filters, respectively. The RACH message receiving manager 935 may be configured as or otherwise support a means for receiving, based on the first random access message, the second random access message, or both, a third random access message of the random access procedure, where the third random access message is associated with one of the first spatial filter or the second spatial filter. The RACH message transmitting manager 930 may be configured as or otherwise support a means for transmitting, based on the third random access message, a fourth random access message of the random access procedure, where the fourth random access message is transmitted in accordance with the first spatial filter or the second spatial filter that is associated with the third random access message.

Additionally or alternatively, the communications manager 920 may support wireless communication at a UE in accordance with examples as disclosed herein. The RACH message transmitting manager 930 may be configured as or otherwise support a means for transmitting a first set of random access messages of a random access procedure in accordance with a first set of one or more spatial filters, where the first set of random access messages are associated with a first value of a power ramping counter. The spatial filter manager 945 may be configured as or otherwise support a means for selecting a second set of one or more spatial filters based on identifying a failure of the random access procedure. The power ramping counter manager 950 may be configured as or otherwise support a means for setting the power ramping counter to a value based on a comparison of the first set of one or more spatial filters and the second set of one or more spatial filters. The RACH message transmitting manager 930 may be configured as or otherwise support a means for transmitting a second set of random access messages associated with a second random access procedure in accordance with the second set of one or more spatial filters and using a transmission power that is based on the value of the power ramping counter.

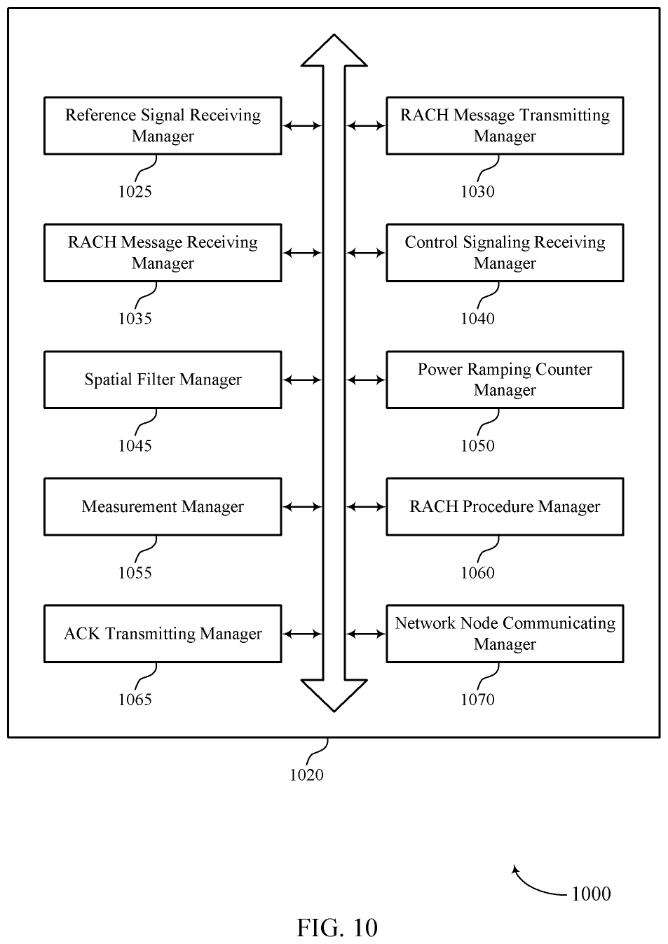

FIG. 10 shows a block diagram 1000 of a communications manager 1020 that supports techniques for multiple PRACH transmissions in accordance with aspects of the present disclosure. The communications manager 1020 may be an example of aspects of a communications manager 820, a communications manager 920, or both, as described herein. The communications manager 1020, or various components thereof, may be an example of means for performing various aspects of techniques for multiple PRACH transmissions as described herein. For example, the communications manager 1020 may include a reference signal receiving manager 1025, a RACH message transmitting manager 1030, a RACH message receiving manager 1035, a control signaling receiving manager 1040, a spatial filter manager 1045, a power ramping counter manager 1050, a measurement manager 1055, a RACH procedure manager 1060, an ACK transmitting manager 1065, a network node communicating manager 1070, or any combination thereof. Each of these components may communicate, directly or indirectly, with one another (e.g., via one or more buses).

The communications manager 1020 may support wireless communication at a UE in accordance with examples as disclosed herein. The reference signal receiving manager 1025 may be configured as or otherwise support a means for receiving a set of multiple reference signals associated with a set of multiple spatial filters. The RACH message transmitting manager 1030 may be configured as or otherwise support a means for transmitting, using a transmission power based on a single spatial filter of the set of multiple spatial filters, a first random access message of a random access procedure with a first spatial filter of the set of multiple spatial filters. The RACH message receiving manager 1035 may be configured as or otherwise support a means for transmitting, using the transmission power based on the single spatial filter of the set of multiple spatial filters, a second random access message of the random access procedure with a second spatial filter of the set of multiple spatial filters. In some examples, the transmission power is based on a pathloss metric associated with the single spatial filter.

In some examples, the measurement manager 1055 may be configured as or otherwise support a means for performing measurements on the set of multiple reference signals. In some examples, the spatial filter manager 1045 may be configured as or otherwise support a means for determining a set of multiple sets of characteristics associated with the set of multiple spatial filters based on the measurements, the set of multiple sets of characteristics including a first set of characteristics associated with the first spatial filter and a second set of characteristics associated with the second spatial filter, the set of multiple sets of characteristics including an RSRP measurement, a pathloss metric, or both. In some examples, the spatial filter manager 1045 may be configured as or otherwise support a means for selecting the single spatial filter associated with the transmission power based on a comparison of the first set of characteristics, the second set of characteristics, or both, with the set of multiple sets of characteristics.

In some examples, the control signaling receiving manager 1040 may be configured as or otherwise support a means for receiving control signaling indicating one or more parameters associated with selection of spatial filters at the UE, where the single spatial filter is selected in accordance with the one or more parameters.

In some examples, the set of multiple reference signals include an SSB message, a CSI-RS, or both. In some examples, the random access procedure includes a four-step random access procedure or a two-step random access procedure. In some examples, the random access procedure includes a four-step random access procedure. In some examples, the first random access message, the second random access message, or both, include repetitions of a first message of the four-step random access procedure.

Additionally or alternatively, the communications manager 1020 may support wireless communication at a UE in accordance with examples as disclosed herein. The control signaling receiving manager 1040 may be configured as or otherwise support a means for receiving control signaling indicating a set of multiple sets of power control parameters associated with a set of multiple spatial filters. In some examples, the RACH message transmitting manager 1030 may be configured as or otherwise support a means for transmitting, using a first transmission power and in accordance with a first spatial filter of the set of multiple spatial filters, a first random access message of a random access procedure, where the first transmission power is based on a first set of power control parameters associated with the first spatial filter indicated via the control signaling, the first set of power control parameters included within the set of multiple sets of power control parameters. In some examples, the RACH message transmitting manager 1030 may be configured as or otherwise support a means for transmitting, using a second transmission power and in accordance with a second spatial filter of the set of multiple spatial filters, a second random access message of the random access procedure, where the second transmission power is based on a second set of power control parameters associated with the second spatial filter indicated via the control signaling, the second set of power control parameters included within the set of multiple sets of power control parameters.

In some examples, the first transmission power is based on a first pathloss metric and the first set of power control parameters. In some examples, the second transmission power is based on a second pathloss metric and the second set of power control parameters.

In some examples, the spatial filter manager 1045 may be configured as or otherwise support a means for selecting the first spatial filter and the second spatial filter based on a comparison of a first set of characteristics associated with the first spatial filter, a second set of characteristics associated with the second spatial filter, or both, with a set of multiple sets of characteristics associated with the set of multiple spatial filters, where the first set of characteristics, the second set of characteristics, or both, include an RSRP measurement, a pathloss metric, or both, where transmitting the first and second random access messages is based on selecting the first and second spatial filters.

In some examples, the reference signal receiving manager 1025 may be configured as or otherwise support a means for receiving a set of multiple reference signals including an SSB message, a CSI-RS, or both, where the set of multiple sets of characteristics are based on the set of multiple reference signals. In some examples, the set of multiple sets of power control parameters include a preamble received target power parameter, a maximum transmission parameter, a power ramping step parameter, or any combination thereof. In some examples, the random access procedure includes a four-step random access procedure or a two-step random access procedure. In some examples, the random access procedure includes a four-step random access procedure. In some examples, the first random access message, the second random access message, or both, include a first message of the four-step random access procedure.

Additionally or alternatively, the communications manager 1020 may support wireless communication at a UE in accordance with examples as disclosed herein. In some examples, the reference signal receiving manager 1025 may be configured as or otherwise support a means for receiving a set of multiple reference signals associated with a set of multiple spatial filters. In some examples, the RACH message transmitting manager 1030 may be configured as or otherwise support a means for transmitting, based on receiving the set of multiple reference signals, a first random access message and a second random access message of a random access procedure, the first and second random access messages transmitted in accordance with a first spatial filter and a second spatial filter from the set of multiple spatial filters, respectively. In some examples, the RACH message receiving manager 1035 may be configured as or otherwise support a means for receiving, based on the first random access message, the second random access message, or both, a third random access message of the random access procedure, where the third random access message is associated with one of the first spatial filter or the second spatial filter. In some examples, the RACH message transmitting manager 1030 may be configured as or otherwise support a means for transmitting, based on the third random access message, a fourth random access message of the random access procedure, where the fourth random access message is transmitted in accordance with the first spatial filter or the second spatial filter that is associated with the third random access message.

In some examples, the RACH message receiving manager 1035 may be configured as or otherwise support a means for receiving, in response to the fourth random access message, a fifth random access message of the random access procedure, where the fifth random access message is associated with the first spatial filter or the second spatial filter that is associated with the fourth random access message.

In some examples, the ACK transmitting manager 1065 may be configured as or otherwise support a means for transmitting an acknowledgement message in response to the fifth random access message, where the acknowledgement message is associated with a completion of the random access procedure. In some examples, the network node communicating manager 1070 may be configured as or otherwise support a means for communicating with a network node based on the completion of the random access procedure.

In some examples, to support receiving the third random access message, the RACH message receiving manager 1035 may be configured as or otherwise support a means for receiving a first repetition of the third random access message associated with the first spatial filter. In some examples, to support receiving the third random access message, the RACH message receiving manager 1035 may be configured as or otherwise support a means for refraining from monitoring for additional repetitions of the third random access message associated with additional spatial filters based on receiving the first repetition of the third random access message, where the fourth random access message is transmitted in accordance with the first spatial filter based on receiving the first repetition of the third random access message associated with the first spatial filter.

In some examples, to support receiving the third random access message, the RACH message receiving manager 1035 may be configured as or otherwise support a means for receiving a first repetition of the third random access message associated with the second spatial filter, where the fourth random access message is transmitted in accordance with the second spatial filter based on receiving the first repetition of the third random access message associated with the second spatial filter.

In some examples, the spatial filter manager 1045 may be configured as or otherwise support a means for selecting the first spatial filter and the second spatial filter based on a comparison of a first pathloss metric associated with the first spatial filter, a second pathloss metric associated with the second spatial filter, or both, with a set of multiple pathloss metrics associated with the set of multiple spatial filters, where transmitting the first and second random access messages is based on selecting the first and second spatial filters.

In some examples, the set of multiple reference signals include an SSB message, a CSI-RS, or both. In some examples, the random access procedure includes a four-step random access procedure or a two-step random access procedure.

In some examples, the random access procedure includes a four-step random access procedure. In some examples, the first random access message, the second random access message, or both, include repetitions of a first message of the four-step random access procedure. In some examples, the third random access message includes a second message of the four-step random access procedure. In some examples, the fourth random access message includes a third message of the four-step random access procedure.

Additionally or alternatively, the communications manager 1020 may support wireless communication at a UE in accordance with examples as disclosed herein. In some examples, the RACH message transmitting manager 1030 may be configured as or otherwise support a means for transmitting a first set of random access messages of a random access procedure in accordance with a first set of one or more spatial filters, where the first set of random access messages are associated with a first value of a power ramping counter. The spatial filter manager 1045 may be configured as or otherwise support a means for selecting a second set of one or more spatial filters based on identifying a failure of the random access procedure. The power ramping counter manager 1050 may be configured as or otherwise support a means for setting the power ramping counter to a value based on a comparison of the first set of one or more spatial filters and the second set of one or more spatial filters. In some examples, the RACH message transmitting manager 1030 may be configured as or otherwise support a means for transmitting a second set of random access messages associated with a second random access procedure in accordance with the second set of one or more spatial filters and using a transmission power that is based on the value of the power ramping counter.

In some examples, setting the power ramping counter includes incrementing the power ramping counter to the value based on the first and second sets of one or more spatial filters being the same, or retaining the value of the power ramping counter based on the second set of one or more spatial filters including at least one spatial filter that is not included within the first set of one or more spatial filters.

In some examples, the first set of random access messages are transmitted via a second transmission power, and the RACH message transmitting manager 1030 may be configured as or otherwise support a means for transmitting the second set of random access messages via the transmission power that is greater than the second transmission power based on incrementing the power ramping counter. In some examples, the first set of random access messages are transmitted via the transmission power, and the RACH message transmitting manager 1030 may be configured as or otherwise support a means for transmitting the second set of random access messages via the transmission power that is the same as the transmission power used to transmit the first set of random access messages based on retaining the first value of the power ramping counter.

In some examples, the first set of random access messages include repetitions of a first message of the random access procedure, and the RACH procedure manager 1060 may be configured as or otherwise support a means for identifying a failure of the random access procedure based on an absence of a received second message of the random access procedure within a random access response window, an absence of a received fourth message of the random access procedure within the random access response window, an expiration of a contention timer, a contention resolution failing to satisfy a contention resolution threshold, or any combination thereof, where selecting the second set of one or more spatial filters is based on identifying the failure of the random access procedure.

In some examples, the random access procedure includes a four-step random access procedure or a two-step random access procedure. In some examples, the random access procedure includes a four-step random access procedure. In some examples, the first set of random access messages, the second set of random access messages, or both, include repetitions of a first message of the four-step random access procedure, repetitions of a third message of the random access procedure, or both.

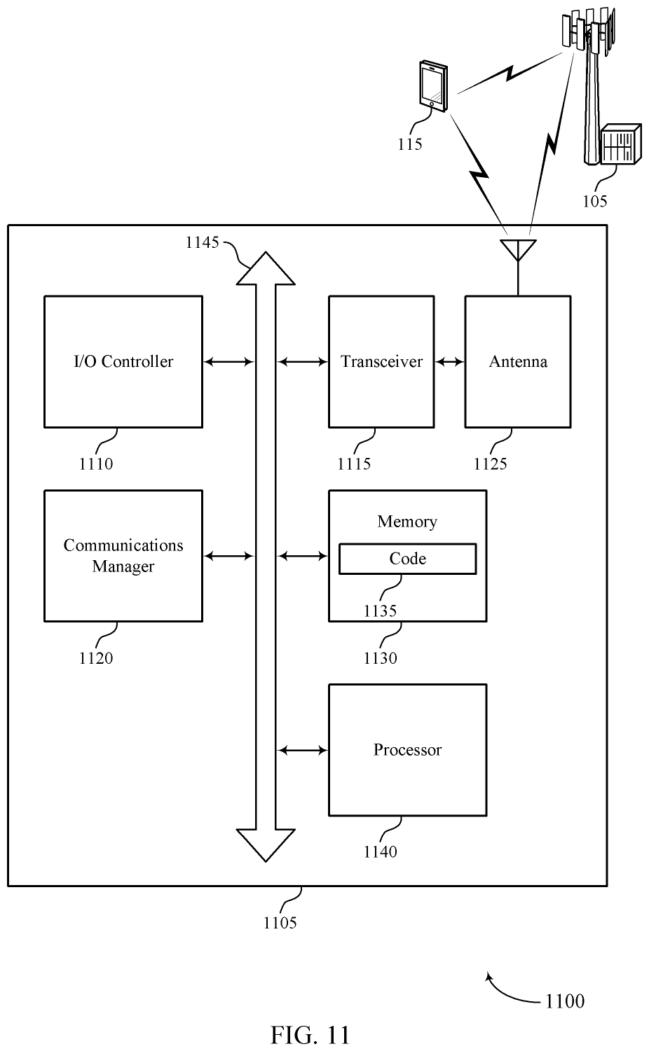

FIG. 11 shows a diagram of a system 1100 including a device 1105 that supports techniques for multiple PRACH transmissions in accordance with aspects of the present disclosure. The device 1105 may be an example of or include the components of a device 805, a device 905, or a UE 115 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for multiple PRACH transmissions). For example, the device 1105 or a component of the device 1105 may include a processor 1140 and memory 1130 coupled to the processor 1140, the processor 1140 and memory 1130 configured to perform various functions described herein.

The communications manager 1120 may support wireless communication at a UE in accordance with examples as disclosed herein. For example, the communications manager 1120 may be configured as or otherwise support a means for receiving a set of multiple reference signals associated with a set of multiple spatial filters. The communications manager 1120 may be configured as or otherwise support a means for transmitting, using a transmission power based on a single spatial filter of the set of multiple spatial filters, a first random access message of a random access procedure with a first spatial filter of the set of multiple spatial filters. The communications manager 1120 may be configured as or otherwise support a means for transmitting, using the transmission power based on the single spatial filter of the set of multiple spatial filters, a second random access message of the random access procedure with a second spatial filter of the set of multiple spatial filters.

Additionally or alternatively, the communications manager 1120 may support wireless communication at a UE in accordance with examples as disclosed herein. For example, the communications manager 1120 may be configured as or otherwise support a means for receiving control signaling indicating a set of multiple sets of power control parameters associated with a set of multiple spatial filters. The communications manager 1120 may be configured as or otherwise support a means for transmitting, using a first transmission power and in accordance with a first spatial filter of the set of multiple spatial filters, a first random access message of a random access procedure, where the first transmission power is based on a first set of power control parameters associated with the first spatial filter indicated via the control signaling, the first set of power control parameters included within the set of multiple sets of power control parameters. The communications manager 1120 may be configured as or otherwise support a means for transmitting, using a second transmission power and in accordance with a second spatial filter of the set of multiple spatial filters, a second random access message of the random access procedure, where the second transmission power is based on a second set of power control parameters associated with the second spatial filter indicated via the control signaling, the second set of power control parameters included within the set of multiple sets of power control parameters.

Additionally or alternatively, the communications manager 1120 may support wireless communication at a UE in accordance with examples as disclosed herein. For example, the communications manager 1120 may be configured as or otherwise support a means for receiving a set of multiple reference signals associated with a set of multiple spatial filters. The communications manager 1120 may be configured as or otherwise support a means for transmitting, based on receiving the set of multiple reference signals, a first random access message and a second random access message of a random access procedure, the first and second random access messages transmitted in accordance with a first spatial filter and a second spatial filter from the set of multiple spatial filters, respectively. The communications manager 1120 may be configured as or otherwise support a means for receiving, based on the first random access message, the second random access message, or both, a third random access message of the random access procedure, where the third random access message is associated with one of the first spatial filter or the second spatial filter. The communications manager 1120 may be configured as or otherwise support a means for transmitting, based on the third random access message, a fourth random access message of the random access procedure, where the fourth random access message is transmitted in accordance with the first spatial filter or the second spatial filter that is associated with the third random access message.

Additionally or alternatively, the communications manager 1120 may support wireless communication at a UE in accordance with examples as disclosed herein. For example, the communications manager 1120 may be configured as or otherwise support a means for transmitting a first set of random access messages of a random access procedure in accordance with a first set of one or more spatial filters, where the first set of random access messages are associated with a first value of a power ramping counter. The communications manager 1120 may be configured as or otherwise support a means for selecting a second set of one or more spatial filters based on identifying a failure of the random access procedure. The communications manager 1120 may be configured as or otherwise support a means for setting the power ramping counter to a value based on a comparison of the first set of one or more spatial filters and the second set of one or more spatial filters. The communications manager 1120 may be configured as or otherwise support a means for transmitting a second set of random access messages associated with a second random access procedure in accordance with the second set of one or more spatial filters and using a transmission power that is based on the value of the power ramping counter.

By including or configuring the communications manager 1120 in accordance with examples as described herein, the device 1105 may support techniques which enable UEs 115 and base stations 105 to more efficiently and reliably determine what transmit powers will be used to transmit repetitions of RACH messages associated with RACH procedures performed between the UEs 115 and the network. In this regard, techniques described herein may enable the network (e.g., base stations 105) to expect certain transmission powers of the RACH procedure, combine repetitions of RACH messages, and efficiently decode RACH messages. Moreover, aspects described herein may improve the ability of the network and UEs 115 to perform RACH procedures using multiple spatial filters, which increases redundancy of RACH messages and improves the probability that the RACH procedure will be successful. Further, aspects described herein may enable wireless devices to more efficiently and reliably determine which spatial filter(s) will be used to perform RACH procedures, further improving the reliability of RACH procedures, reducing latency at UEs 115, and improving overall user experience, among other benefits.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for multiple PRACH transmissions as described herein, or the processor 1140 and the memory 1130 may be otherwise configured to perform or support such operations.

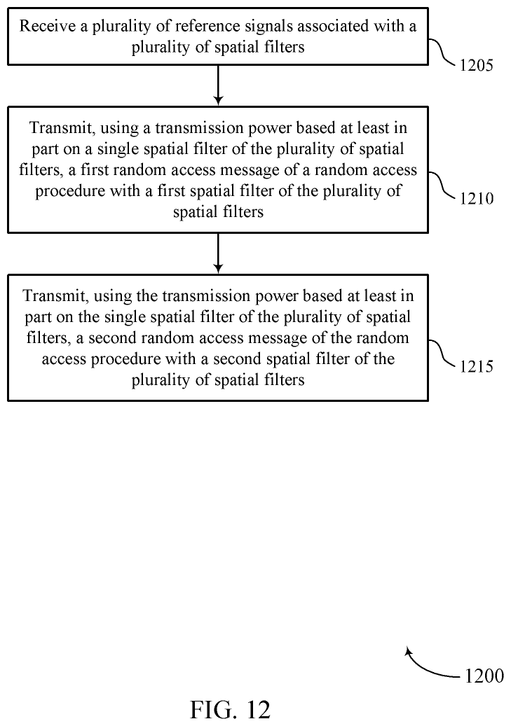

FIG. 12 shows a flowchart illustrating a method 1200 that supports techniques for multiple PRACH transmissions in accordance with aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1205, the method may include receiving a set of multiple reference signals associated with a set of multiple spatial filters. The operations of 1205 may be performed in accordance with examples as disclosed herein. In some examples, aspects of the operations of 1205 may be performed by a reference signal receiving manager 1025 as described with reference to FIG. 10.

At 1210, the method may include transmitting, using a transmission power based on a single spatial filter of the set of multiple spatial filters, a first random access message of a random access procedure with a first spatial filter of the set of multiple spatial filters. The operations of 1210 may be performed in accordance with examples as disclosed herein. In some examples, aspects of the operations of 1210 may be performed by a RACH message transmitting manager 1030 as described with reference to FIG. 10.

At 1215, the method may include transmitting, using the transmission power based on the single spatial filter of the set of multiple spatial filters, a second random access message of the random access procedure with a second spatial filter of the set of multiple spatial filters. The operations of 1215 may be performed in accordance with examples as disclosed herein. In some examples, aspects of the operations of 1215 may be performed by a RACH message receiving manager 1035 as described with reference to FIG. 10.

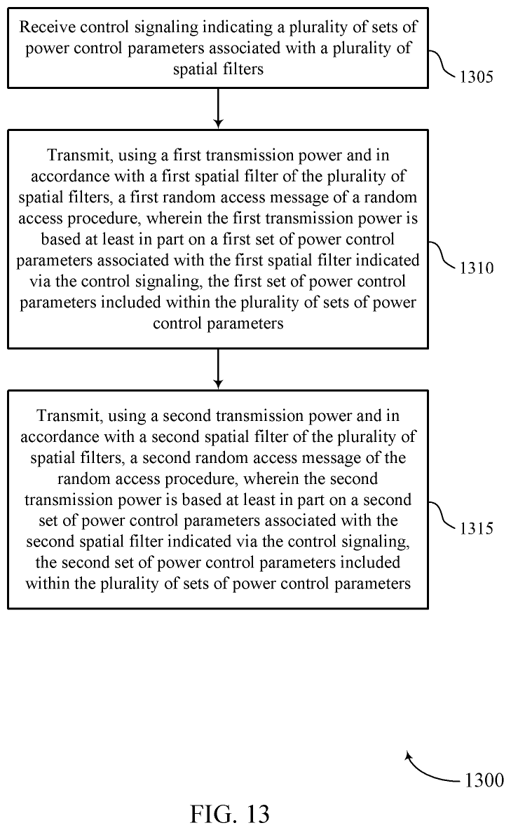

FIG. 13 shows a flowchart illustrating a method 1300 that supports techniques for multiple PRACH transmissions in accordance with aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1305, the method may include receiving control signaling indicating a set of multiple sets of power control parameters associated with a set of multiple spatial filters. The operations of 1305 may be performed in accordance with examples as disclosed herein. In some examples, aspects of the operations of 1305 may be performed by a control signaling receiving manager 1040 as described with reference to FIG. 10.

At 1310, the method may include transmitting, using a first transmission power and in accordance with a first spatial filter of the set of multiple spatial filters, a first random access message of a random access procedure, where the first transmission power is based on a first set of power control parameters associated with the first spatial filter indicated via the control signaling, the first set of power control parameters included within the set of multiple sets of power control parameters. The operations of 1310 may be performed in accordance with examples as disclosed herein. In some examples, aspects of the operations of 1310 may be performed by a RACH message transmitting manager 1030 as described with reference to FIG. 10.

At 1315, the method may include transmitting, using a second transmission power and in accordance with a second spatial filter of the set of multiple spatial filters, a second random access message of the random access procedure, where the second transmission power is based on a second set of power control parameters associated with the second spatial filter indicated via the control signaling, the second set of power control parameters included within the set of multiple sets of power control parameters. The operations of 1315 may be performed in accordance with examples as disclosed herein. In some examples, aspects of the operations of 1315 may be performed by a RACH message transmitting manager 1030 as described with reference to FIG. 10.

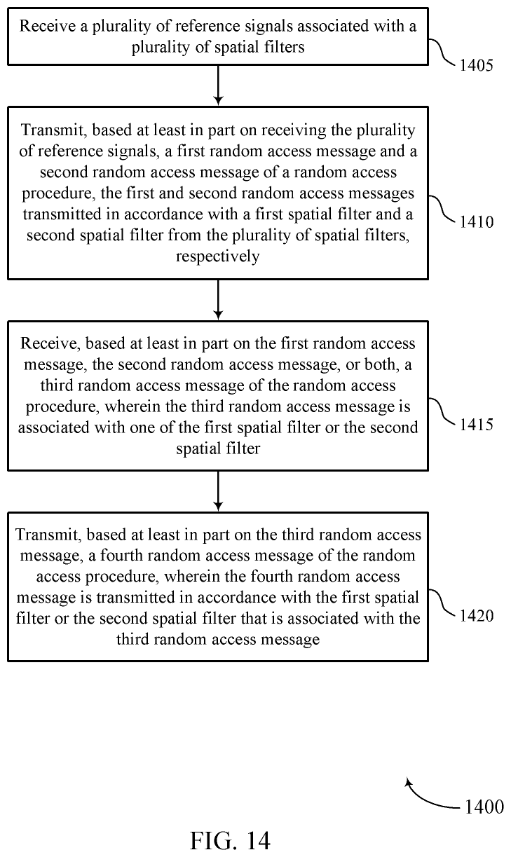

FIG. 14 shows a flowchart illustrating a method 1400 that supports techniques for multiple PRACH transmissions in accordance with aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1405, the method may include receiving a set of multiple reference signals associated with a set of multiple spatial filters. The operations of 1405 may be performed in accordance with examples as disclosed herein. In some examples, aspects of the operations of 1405 may be performed by a reference signal receiving manager 1025 as described with reference to FIG. 10.

At 1410, the method may include transmitting, based on receiving the set of multiple reference signals, a first random access message and a second random access message of a random access procedure, the first and second random access messages transmitted in accordance with a first spatial filter and a second spatial filter from the set of multiple spatial filters, respectively. The operations of 1410 may be performed in accordance with examples as disclosed herein. In some examples, aspects of the operations of 1410 may be performed by a RACH message transmitting manager 1030 as described with reference to FIG. 10.

At 1415, the method may include receiving, based on the first random access message, the second random access message, or both, a third random access message of the random access procedure, where the third random access message is associated with one of the first spatial filter or the second spatial filter. The operations of 1415 may be performed in accordance with examples as disclosed herein. In some examples, aspects of the operations of 1415 may be performed by a RACH message receiving manager 1035 as described with reference to FIG. 10.

At 1420, the method may include transmitting, based on the third random access message, a fourth random access message of the random access procedure, where the fourth random access message is transmitted in accordance with the first spatial filter or the second spatial filter that is associated with the third random access message. The operations of 1420 may be performed in accordance with examples as disclosed herein. In some examples, aspects of the operations of 1420 may be performed by a RACH message transmitting manager 1030 as described with reference to FIG. 10.

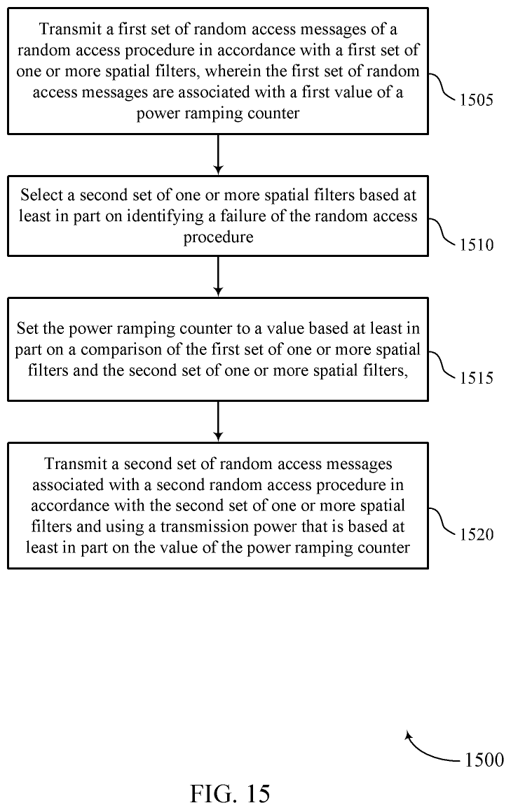

FIG. 15 shows a flowchart illustrating a method 1500 that supports techniques for multiple PRACH transmissions in accordance with aspects of the present disclosure. The operations of the method 1500 may be implemented by a UE or its components as described herein. For example, the operations of the method 1500 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1505, the method may include transmitting a first set of random access messages of a random access procedure in accordance with a first set of one or more spatial filters, where the first set of random access messages are associated with a first value of a power ramping counter. The operations of 1505 may be performed in accordance with examples as disclosed herein. In some examples, aspects of the operations of 1505 may be performed by a RACH message transmitting manager 1030 as described with reference to FIG. 10.

At 1510, the method may include selecting a second set of one or more spatial filters based on identifying a failure of the random access procedure. The operations of 1510 may be performed in accordance with examples as disclosed herein. In some examples, aspects of the operations of 1510 may be performed by a spatial filter manager 1045 as described with reference to FIG. 10.

At 1515, the method may include setting the power ramping counter to a value based on a comparison of the first set of one or more spatial filters and the second set of one or more spatial filters. The operations of 1515 may be performed in accordance with examples as disclosed herein. In some examples, aspects of the operations of 1515 may be performed by a power ramping counter manager 1050 as described with reference to FIG. 10.

At 1520, the method may include transmitting a second set of random access messages associated with a second random access procedure in accordance with the second set of one or more spatial filters and using a transmission power that is based on the value of the power ramping counter. The operations of 1520 may be performed in accordance with examples as disclosed herein. In some examples, aspects of the operations of 1520 may be performed by a RACH message transmitting manager 1030 as described with reference to FIG. 10.

The following provides an overview of aspects of the present disclosure:

Aspect 1: A method for wireless communication at a UE, comprising: receiving a plurality of reference signals associated with a plurality of spatial filters; transmitting, using a transmission power based at least in part on a single spatial filter of the plurality of spatial filters, a first random access message of a random access procedure with a first spatial filter of the plurality of spatial filters; and transmitting, using the transmission power based at least in part on the single spatial filter of the plurality of spatial filters, a second random access message of the random access procedure with a second spatial filter of the plurality of spatial filters.

Aspect 2: The method of aspect 1, wherein the transmission power is based at least in part on a pathloss metric associated with the single spatial filter.

Aspect 3: The method of any of aspects 1 through 2, further comprising: performing measurements on the plurality of reference signals; determining a plurality of sets of characteristics associated with the plurality of spatial filters based at least in part on the measurements, the plurality of sets of characteristics including a first set of characteristics associated with the first spatial filter and a second set of characteristics associated with the second spatial filter, the plurality of sets of characteristics comprising an RSRP measurement, a pathloss metric, or both; and selecting the single spatial filter associated with the transmission power based at least in part on a comparison of the first set of characteristics, the second set of characteristics, or both, with the plurality of sets of characteristics.

Aspect 4: The method of any of aspects 1 through 3, further comprising: receiving control signaling indicating one or more parameters associated with selection of spatial filters at the UE, wherein the single spatial filter is selected in accordance with the one or more parameters.

Aspect 5: The method of any of aspects 1 through 4, wherein the plurality of reference signals comprise an SSB message, a CSI-RS, or both.

Aspect 6: The method of any of aspects 1 through 5, wherein the random access procedure comprises a four-step random access procedure or a two-step random access procedure.

Aspect 7: The method of any of aspects 1 through 6, wherein the random access procedure comprises a four-step random access procedure, and the first random access message, the second random access message, or both, comprise repetitions of a first message of the four-step random access procedure.

Aspect 8: A method for wireless communication at a UE, comprising: receiving control signaling indicating a plurality of sets of power control parameters associated with a plurality of spatial filters; transmitting, using a first transmission power and in accordance with a first spatial filter of the plurality of spatial filters, a first random access message of a random access procedure, wherein the first transmission power is based at least in part on a first set of power control parameters associated with the first spatial filter indicated via the control signaling, the first set of power control parameters included within the plurality of sets of power control parameters; and transmitting, using a second transmission power and in accordance with a second spatial filter of the plurality of spatial filters, a second random access message of the random access procedure, wherein the second transmission power is based at least in part on a second set of power control parameters associated with the second spatial filter indicated via the control signaling, the second set of power control parameters included within the plurality of sets of power control parameters.

Aspect 9: The method of aspect 8, wherein the first transmission power is based at least in part on a first pathloss metric and the first set of power control parameters, and the second transmission power is based at least in part on a second pathloss metric and the second set of power control parameters.

Aspect 10: The method of any of aspects 8 through 9, further comprising: selecting the first spatial filter and the second spatial filter based at least in part on a comparison of a first set of characteristics associated with the first spatial filter, a second set of characteristics associated with the second spatial filter, or both, with a plurality of sets of characteristics associated with the plurality of spatial filters, wherein the first set of characteristics, the second set of characteristics, or both, comprise an RSRP measurement, a pathloss metric, or both, wherein transmitting the first and second random access messages is based at least in part on selecting the first and second spatial filters.

Aspect 11: The method of aspect 10, further comprising: receiving a plurality of reference signals comprising an SSB message, a CSI-RS, or both, wherein the plurality of sets of characteristics are based at least in part on the plurality of reference signals.

Aspect 12: The method of any of aspects 8 through 11, wherein the plurality of sets of power control parameters comprise a preamble received target power parameter, a maximum transmission parameter, a power ramping step parameter, or any combination thereof.

Aspect 13: The method of any of aspects 8 through 12, wherein the random access procedure comprises a four-step random access procedure or a two-step random access procedure.

Aspect 14: The method of any of aspects 8 through 13, wherein the random access procedure comprises a four-step random access procedure, and the first random access message, the second random access message, or both, comprise a first message of the four-step random access procedure.

Aspect 15: A method for wireless communication at a UE, comprising: receiving a plurality of reference signals associated with a plurality of spatial filters; transmitting, based at least in part on receiving the plurality of reference signals, a first random access message and a second random access message of a random access procedure, the first and second random access messages transmitted in accordance with a first spatial filter and a second spatial filter from the plurality of spatial filters, respectively; receiving, based at least in part on the first random access message, the second random access message, or both, a third random access message of the random access procedure, wherein the third random access message is associated with one of the first spatial filter or the second spatial filter; and transmitting, based at least in part on the third random access message, a fourth random access message of the random access procedure, wherein the fourth random access message is transmitted in accordance with the first spatial filter or the second spatial filter that is associated with the third random access message.

Aspect 16: The method of aspect 15, further comprising: receiving, in response to the fourth random access message, a fifth random access message of the random access procedure, wherein the fifth random access message is associated with the first spatial filter or the second spatial filter that is associated with the fourth random access message.

Aspect 17: The method of aspect 16, further comprising: transmitting an acknowledgement message in response to the fifth random access message, wherein the acknowledgement message is associated with a completion of the random access procedure; and communicating with a network node based at least in part on the completion of the random access procedure.

Aspect 18: The method of any of aspects 15 through 17, wherein receiving the third random access message comprises: receiving a first repetition of the third random access message associated with the first spatial filter; and refraining from monitoring for additional repetitions of the third random access message associated with additional spatial filters based at least in part on receiving the first repetition of the third random access message, wherein the fourth random access message is transmitted in accordance with the first spatial filter based at least in part on receiving the first repetition of the third random access message associated with the first spatial filter.

Aspect 19: The method of any of aspects 15 through 18, wherein receiving the third random access message comprises: receiving a first repetition of the third random access message associated with the second spatial filter, wherein the fourth random access message is transmitted in accordance with the second spatial filter based at least in part on receiving the first repetition of the third random access message associated with the second spatial filter.

Aspect 20: The method of any of aspects 15 through 19, further comprising: selecting the first spatial filter and the second spatial filter based at least in part on a comparison of a first pathloss metric associated with the first spatial filter, a second pathloss metric associated with the second spatial filter, or both, with a plurality of pathloss metrics associated with the plurality of spatial filters, wherein transmitting the first and second random access messages is based at least in part on selecting the first and second spatial filters.

Aspect 21: The method of any of aspects 15 through 20, wherein the plurality of reference signals comprise an SSB message, a CSI-RS, or both.

Aspect 22: The method of any of aspects 15 through 21, wherein the random access procedure comprises a four-step random access procedure or a two-step random access procedure.

Aspect 23: The method of any of aspects 15 through 22, wherein the random access procedure comprises a four-step random access procedure, and the first random access message, the second random access message, or both, comprise repetitions of a first message of the four-step random access procedure, the third random access message comprises a second message of the four-step random access procedure, and the fourth random access message comprises a third message of the four-step random access procedure.

Aspect 24: A method for wireless communication at a UE, comprising: transmitting a first set of random access messages of a random access procedure in accordance with a first set of one or more spatial filters, wherein the first set of random access messages are associated with a first value of a power ramping counter; selecting a second set of one or more spatial filters based at least in part on identifying a failure of the random access procedure; setting the power ramping counter to a value based at least in part on a comparison of the first set of one or more spatial filters and the second set of one or more spatial filters; and transmitting a second set of random access messages associated with a second random access procedure in accordance with the second set of one or more spatial filters and using a transmission power that is based at least in part on the value of the power ramping counter.

Aspect 25: The method of aspect 24, wherein setting the power ramping counter comprises incrementing the power ramping counter to the value based at least in part on the first and second sets of one or more spatial filters being the same, or retaining the value of the power ramping counter based at least in part on the second set of one or more spatial filters including at least one spatial filter that is not included within the first set of one or more spatial filters.

Aspect 26: The method of any of aspects 24 through 25, wherein the first set of random access messages are transmitted via a second transmission power, and wherein setting the power ramping counter comprises incrementing the power ramping counter, the method further comprising: transmitting the second set of random access messages via the transmission power that is greater than the second transmission power based at least in part on incrementing the power ramping counter.

Aspect 27: The method of any of aspects 24 through 26, wherein the first set of random access messages are transmitted via the transmission power, and wherein setting the power ramping counter comprises retaining the first value of the power ramping counter, the method further comprising: transmitting the second set of random access messages via the transmission power that is the same as the transmission power used to transmit the first set of random access messages based at least in part on retaining the first value of the power ramping counter.

Aspect 28: The method of any of aspects 24 through 27, wherein the first set of random access messages comprise repetitions of a first message of the random access procedure, repetitions of a third message of the random access procedure, or both, the method further comprising: identifying a failure of the random access procedure based at least in part on an absence of a received second message of the random access procedure within a random access response window, an absence of a received fourth message of the random access procedure within the random access response window, an expiration of a contention timer, a contention resolution failing to satisfy a contention resolution threshold, or any combination thereof, wherein selecting the second set of one or more spatial filters is based at least in part on identifying the failure of the random access procedure.

Aspect 29: The method of any of aspects 24 through 28, wherein the random access procedure comprises a four-step random access procedure or a two-step random access procedure.

Aspect 30: The method of any of aspects 24 through 29, wherein the random access procedure comprises a four-step random access procedure, and the first set of random access messages, the second set of random access messages, or both, comprise repetitions of a first message of the four-step random access procedure, repetitions of a third message of the random access procedure, or both.

Aspect 31: An apparatus for wireless communication at a UE, comprising a processor; memory coupled with the processor; and instructions stored in the memory and executable by the processor to cause the apparatus to perform a method of any of aspects 1 through 7.

Aspect 32: An apparatus for wireless communication at a UE, comprising at least one means for performing a method of any of aspects 1 through 7.

Aspect 33: A non-transitory computer-readable medium storing code for wireless communication at a UE, the code comprising instructions executable by a processor to perform a method of any of aspects 1 through 7.

Aspect 34: An apparatus for wireless communication at a UE, comprising a processor; memory coupled with the processor; and instructions stored in the memory and executable by the processor to cause the apparatus to perform a method of any of aspects 8 through 14.

Aspect 35: An apparatus for wireless communication at a UE, comprising at least one means for performing a method of any of aspects 8 through 14.

Aspect 36: A non-transitory computer-readable medium storing code for wireless communication at a UE, the code comprising instructions executable by a processor to perform a method of any of aspects 8 through 14.

Aspect 37: An apparatus for wireless communication at a UE, comprising a processor; memory coupled with the processor; and instructions stored in the memory and executable by the processor to cause the apparatus to perform a method of any of aspects 15 through 23.

Aspect 38: An apparatus for wireless communication at a UE, comprising at least one means for performing a method of any of aspects 15 through 23.

Aspect 39: A non-transitory computer-readable medium storing code for wireless communication at a UE, the code comprising instructions executable by a processor to perform a method of any of aspects 15 through 23.

Aspect 40: An apparatus for wireless communication at a UE, comprising a processor; memory coupled with the processor; and instructions stored in the memory and executable by the processor to cause the apparatus to perform a method of any of aspects 24 through 30.

Aspect 41: An apparatus for wireless communication at a UE, comprising at least one means for performing a method of any of aspects 24 through 30.

Aspect 42: A non-transitory computer-readable medium storing code for wireless communication at a UE, the code comprising instructions executable by a processor to perform a method of any of aspects 24 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive a plurality of reference signals associated with a plurality of spatial filters;
transmit, using a transmission power based at least in part on a single spatial filter of the plurality of spatial filters, a first random access message of a random access procedure with a first spatial filter of the plurality of spatial filters; and
transmit, using the transmission power based at least in part on the single spatial filter of the plurality of spatial filters, a second random access message of the random access procedure with a second spatial filter of the plurality of spatial filters.

2. The apparatus of claim 1, wherein the transmission power is based at least in part on a pathloss metric associated with the single spatial filter.

3. The apparatus of claim 1, wherein the instructions are further executable by the processor to cause the apparatus to:
perform measurements on the plurality of reference signals;
determine a plurality of sets of characteristics associated with the plurality of spatial filters based at least in part on the measurements, the plurality of sets of characteristics including a first set of characteristics associated with the first spatial filter and a second set of characteristics associated with the second spatial filter, the plurality of sets of characteristics comprising a reference signal received power measurement, a pathloss metric, or both; and
select the single spatial filter associated with the transmission power based at least in part on a comparison of the first set of characteristics, the second set of characteristics, or both, with the plurality of sets of characteristics.

4. The apparatus of claim 1, wherein the instructions are further executable by the processor to cause the apparatus to:
receive control signaling indicating one or more parameters associated with selection of spatial filters at the UE, wherein the single spatial filter is selected in accordance with the one or more parameters.

5. The apparatus of claim 1, wherein the plurality of reference signals comprise a synchronization signal block message, a channel state information reference signal, or both.

6. The apparatus of claim 1, wherein the random access procedure comprises a four-step random access procedure or a two-step random access procedure.

7. The apparatus of claim 1, wherein the random access procedure comprises a four-step random access procedure, and wherein the first random access message, the second random access message, or both, comprise repetitions of a first message of the four-step random access procedure.

8. An apparatus for wireless communication at a user equipment (UE), comprising:
a processor;
memory coupled with the processor; and
instructions stored in the memory and executable by the processor to cause the apparatus to:
receive control signaling indicating a plurality of sets of power control parameters associated with a plurality of spatial filters;
transmit, using a first transmission power and in accordance with a first spatial filter of the plurality of spatial filters, a first random access message of a random access procedure, wherein the first transmission power is based at least in part on a first set of power control parameters associated with the first spatial filter indicated via the control signaling, the first set of power control parameters included within the plurality of sets of power control parameters; and
transmit, using a second transmission power and in accordance with a second spatial filter of the plurality of spatial filters, a second random access message of the random access procedure, wherein the second transmission power is based at least in part on a second set of power control parameters associated with the second spatial filter indicated via the control signaling, the second set of power control parameters included within the plurality of sets of power control parameters.

9. The apparatus of claim 8, wherein the first transmission power is based at least in part on a first pathloss metric and the first set of power control parameters, and wherein the second transmission power is based at least in part on a second pathloss metric and the second set of power control parameters.

10. The apparatus of claim 8, wherein the instructions are further executable by the processor to cause the apparatus to:
select the first spatial filter and the second spatial filter based at least in part on a comparison of a first set of characteristics associated with the first spatial filter, a second set of characteristics associated with the second spatial filter, or both, with a plurality of sets of characteristics associated with the plurality of spatial filters, wherein the first set of characteristics, the second set of characteristics, or both, comprise a reference signal received power measurement, a pathloss metric, or both, wherein the first random access message and the second random access message are transmitted based at least in part on selecting the first spatial filter and the second spatial filter.

11. The apparatus of claim 10, wherein the instructions are further executable by the processor to cause the apparatus to:
receive a plurality of reference signals comprising a synchronization signal block message, a channel state information reference signal, or both, wherein the plurality of sets of characteristics are based at least in part on the plurality of reference signals.

12. The apparatus of claim 8, wherein the plurality of sets of power control parameters comprise a preamble received target power parameter, a maximum transmission parameter, a power ramping step parameter, or any combination thereof.

13. The apparatus of claim 8, wherein the random access procedure comprises a four-step random access procedure or a two-step random access procedure.

14. The apparatus of claim 8, wherein the random access procedure comprises a four-step random access procedure, and wherein the first random access message, the second random access message, or both, comprise a first message of the four-step random access procedure.

15. An apparatus for wireless communication at a user equipment (UE), comprising:
a processor;
memory coupled with the processor; and
instructions stored in the memory and executable by the processor to cause the apparatus to:
receive a plurality of reference signals associated with a plurality of spatial filters;
transmit, based at least in part on receiving the plurality of reference signals, a first random access message and a second random access message of a random access procedure, the first random access message and the second random access message transmitted in accordance with a first spatial filter and a second spatial filter from the plurality of spatial filters, respectively;
receive, based at least in part on the first random access message, the second random access message, or both, a third random access message of the random access procedure, wherein the third random access message is associated with one of the first spatial filter or the second spatial filter; and
transmit, based at least in part on the third random access message, a fourth random access message of the random access procedure, wherein the fourth random access message is transmitted in accordance with the first spatial filter or the second spatial filter that is associated with the third random access message.

16. The apparatus of claim 15, wherein the instructions are further executable by the processor to cause the apparatus to:
receive, in response to the fourth random access message, a fifth random access message of the random access procedure, wherein the fifth random access message is associated with the first spatial filter or the second spatial filter that is associated with the fourth random access message.

17. The apparatus of claim 16, wherein the instructions are further executable by the processor to cause the apparatus to:
transmit an acknowledgement message in response to the fifth random access message, wherein the acknowledgement message is associated with a completion of the random access procedure; and
communicate with a network node based at least in part on the completion of the random access procedure.

18. The apparatus of claim 15, wherein the instructions to receive the third random access message are executable by the processor to cause the apparatus to:
receive a first repetition of the third random access message associated with the first spatial filter; and
refrain from monitoring for additional repetitions of the third random access message associated with additional spatial filters based at least in part on receiving the first repetition of the third random access message, wherein the fourth random access message is transmitted in accordance with the first spatial filter based at least in part on receiving the first repetition of the third random access message associated with the first spatial filter.

19. The apparatus of claim 15, wherein the instructions to receive the third random access message are executable by the processor to cause the apparatus to:
receive a first repetition of the third random access message associated with the second spatial filter, wherein the fourth random access message is transmitted in accordance with the second spatial filter based at least in part on receiving the first repetition of the third random access message associated with the second spatial filter.

20. The apparatus of claim 15, wherein the instructions are further executable by the processor to cause the apparatus to:
select the first spatial filter and the second spatial filter based at least in part on a comparison of a first pathloss metric associated with the first spatial filter, a second pathloss metric associated with the second spatial filter, or both, with a plurality of pathloss metrics associated with the plurality of spatial filters, wherein the first random access message and the second random access message are transmitted based at least in part on selecting the first spatial filter and the second spatial filter.

21. The apparatus of claim 15, wherein the plurality of reference signals comprise a synchronization signal block message, a channel state information reference signal, or both.

22. The apparatus of claim 15, wherein the random access procedure comprises a four-step random access procedure or a two-step random access procedure.

23. The apparatus of claim 15, wherein the random access procedure comprises a four-step random access procedure, and wherein the first random access message, the second random access message, or both, comprise repetitions of a first message of the four-step random access procedure, the third random access message comprises a second message of the four-step random access procedure, and the fourth random access message comprises a third message of the four-step random access procedure.

24. An apparatus for wireless communication at a user equipment (UE), comprising:
a processor;
memory coupled with the processor; and
instructions stored in the memory and executable by the processor to cause the apparatus to:
transmit a first set of random access messages of a random access procedure in accordance with a first set of one or more spatial filters, wherein the first set of random access messages are associated with a first value of a power ramping counter;
select a second set of one or more spatial filters based at least in part on identifying a failure of the random access procedure;
set the power ramping counter to a value based at least in part on a comparison of the first set of one or more spatial filters and the second set of one or more spatial filters; and
transmit a second set of random access messages associated with a second random access procedure in accordance with the second set of one or more spatial filters and using a transmission power that is based at least in part on the value of the power ramping counter.

25. The apparatus of claim 24, wherein setting the power ramping counter comprises incrementing the power ramping counter to the value based at least in part on the first set of one or more spatial filters and the second set of one or more spatial filters being the same, or retaining the value of the power ramping counter based at least in part on the second set of one or more spatial filters including at least one spatial filter that is not included within the first set of one or more spatial filters.

26. The apparatus of claim 24, wherein the first set of random access messages are transmitted via a second transmission power, and the instructions are further executable by the processor to cause the apparatus to:
transmit the second set of random access messages via the transmission power that is greater than the second transmission power based at least in part on incrementing the power ramping counter.

27. The apparatus of claim 24, wherein the first set of random access messages are transmitted via the transmission power, and the instructions are further executable by the processor to cause the apparatus to:
transmit the second set of random access messages via the transmission power that is the same as the transmission power used to transmit the first set of random access messages based at least in part on retaining the first value of the power ramping counter.

28. The apparatus of claim 24, wherein the first set of random access messages comprise repetitions of a first message of the random access procedure, and the instructions are further executable by the processor to cause the apparatus to:
identify a failure of the random access procedure based at least in part on an absence of a received second message of the random access procedure within a random access response window, an absence of a received fourth message of the random access procedure within the random access response window, an expiration of a contention timer, a contention resolution failing to satisfy a contention resolution threshold, or any combination thereof, wherein the second set of one or more spatial filters is selected based at least in part on identifying the failure of the random access procedure.

29. The apparatus of claim 24, wherein the random access procedure comprises a four-step random access procedure or a two-step random access procedure.

30. The apparatus of claim 24, wherein the random access procedure comprises a four-step random access procedure, and wherein the first set of random access messages, the second set of random access messages, or both, comprise repetitions of a first message of the four-step random access procedure, repetitions of a third message of the random access procedure, or both.
